(19) United States
(12) Patent Application Publication
(10) Pub. No.: US 2010/0324243 A1
(43) Pub. Date: Dec. 23, 2010

(54) CATALYST COMPONENT FOR POLYMERIZATION OF ETHYLENE AND PROCESS FOR PRODUCING ETHYLENE POLYMER (1)

(76) Inventor: Yasutoyo Kawashima, Ichihara (JP)

Correspondence Address: BIRCH STEWART KOLASCH & BIRCH, PO BOX 747, FALLS CHURCH, VA, 22040-0747, US

(21) Appl. No.: 12/865,572

(22) PCT Filed: Feb. 17, 2009
(86) PCT No.: PCT/JP2009/053130

§ 371 Date: Jul. 30, 2010

(30) Foreign Application Priority Data
Feb. 20, 2008 (JP) 2008-038495
Oct. 22, 2008 (JP) 2008-271671

(51) Int. Cl. C08F 4/52; B01J 31/14

(52) U.S. Cl. 526/185; 502/152

(57) ABSTRACT

The object is to provide a catalyst component for polymerization of ethylene which can produce an ethylene polymer of high molecular weight which has substantially only an ethyl branch. The catalyst component for polymerization of ethylene is obtained by contacting the following components (A), (B) and (C): component (A): a meso-metallocene compound, component (B): a solid co-catalyst component comprising a particulate carrier and a compound which ionizes a metallocene compound to form an ionic complex and which is supported on the particulate carrier, and component (C): an organoaluminum compound.

### TECHNICAL FIELD

The present invention relates to a catalyst component for polymerization of ethylene and a process for producing ethylene polymer.

### BACKGROUND ART

High-pressure radical process has been known for long as a process for producing polyethylene having branch structure by polymerization of ethylene. According to this process, a low-density polyethylene having complicated branch structure including short-chain branches and long-chain branches is obtained by homopolymerization of ethylene. However, since the high-pressure radical process utilizes a radical reaction, the branch structure of the resulting ethylene polymer can hardly be controlled, and mechanical strength of the ethylene polymer is not necessarily satisfactory. On the other hand, ethylene-α-olefin copolymers obtained by copolymerization of ethylene and α-olefin using an olefin polymerization catalyst comprising a transition metal, such as Ziegler-Natta catalyst or metallocene catalyst, have a short-chain branch structure of a fixed length originating from α-olefin, and hence are excellent in mechanical strength. In this case, however, α-olefin which is more expensive than ethylene must be used as a starting material.

On the other hand, recently, it has been proposed that a branched polyethylene having only ethyl branch which is a short-branch and is competitive in cost is obtained by homopolymerization of ethylene using a homogeneous transition metal catalyst comprising a meso-metallocene compound and methylalumoxane (Non-Patent Documents 1 and 2).

[Non-Patent Document 1]: Lorella Izzo, Lucia Caporaso, Gerardo Senatore, Leone Oliva, “Branched polyethylene by Ethylene Homopolymerization with meso-Zirconocene Catalyst”, Macromolecules, (U.S.A), American Chemical Society, 1999, Vol. 32, No. 21, p. 6913-6916.

[Non-Patent Document 2]: Gianluca Melillo, Lorella Izzo, Roberto Centore, Angela Tuzi, Alexander Z. Voskoboynikov, Leone Oliva, “meso-Me2Si(1-indenyl)2ZrC12/methylalumoxane catalyzed polymerization of the ethylene to ethyl-branched polyethylene”, Journal of Molecular Catalysis A: Chemical, (Holland); ELSEVIER, 2005, Vol. 230, p. 29-33.

### SUMMARY OF THE INVENTION

### Problem to be Solved by the Invention

However, when ethylene is homopolymerized using a homogeneous transition metal catalyst comprising a meso-metallocene compound and methylalumoxane as mentioned above, the resulting polymer is not necessarily satisfactory with respect to molecular weight.

Under the circumstances, the problem to be solved by the present invention is to provide a catalyst component for polymerization of ethylene which can produce an ethylene homopolymer of high molecular weight which has substantially only ethyl branch, and a process for producing an ethylene polymer of high molecular weight which has substantially only ethyl branch.

### Means for Solving the Problem

That is, the first aspect of the present invention relates to a catalyst component for polymerization of ethylene which is obtained by contacting the following components (A), (B) and (C):

component (A): a meso-metallocene compound,

component (B): a solid co-catalyst component comprising a compound which ionizes a metallocene compound to form an ionic complex and which is supported on a particulate carrier, and

component (C): an organoaluminum compound.

The second aspect of the present invention relates to a process for producing an ethylene polymer by polymerizing ethylene in the presence of the above catalyst component for polymerization of ethylene.

### Advantages of the Invention

By using the catalyst component for polymerization of ethylene of the present invention, an ethylene homopolymer of high molecular weight which has substantially only ethyl branch can be produced. Furthermore, according to the process for producing an ethylene polymer of the present invention, an ethylene polymer of high molecular weight which has substantially only ethyl branch can be produced.

### Embodiments for the Invention

The catalyst component for polymerization of ethylene of the present invention is a catalyst component for polymerization of ethylene which is obtained by contacting the following components (A), (B) and (C).

Component (A): a meso-metallocene compound.

Component (B): a solid co-catalyst component comprising a compound which ionizes a metallocene compound to form an ionic complex and which is supported on a particulate carrier.

Component (C): an organoaluminum compound.

The meso-metallocene compound of the component (A) is a transition metal compound which has a meso-cyclopentadienyl type anion skeleton and is represented by the following formula (1).

L¹₂M¹X₂ (1)

M¹ is a transition metal atom of Group 4 in the periodic table. L¹ is a group having a cyclopentadiene type anion skeleton, and two L¹s are linked with each other through a crosslinking group containing one or two or more of carbon atom, silicon atom and germanium atom and are coordinated in meso form. X is a halogen atom, a hydrocarbon group (excluding group having cyclopentadiene type anion skeleton) or a hydrocarbonoxy group.

M¹ in the formula (1) is a transition metal atom of Group 4 in the periodic table (IUPAC 1989), and is preferably titanium atom, zirconium atom or hafnium atom, and more preferably zirconium atom.

L¹ in the formula (1) is a group having a cyclopentadiene type anion skeleton, and two L¹s may be the same or different. Moreover, two L¹s are linked with each other through a crosslinking group containing one or two or more of carbon atom, silicon atom and germanium atom and are coordinated in meso form.

The group having a cyclopentadiene type anion skeleton in L¹ is a η⁵-(substituted) indenyl group, and specific examples thereof are η⁵-indenyl group, η⁵-4,5,6,7-tetrahydroindenyl group, η⁵-2-methylindenyl group, η⁵-3-methylindenyl group, η⁵-4-methylindenyl group, η⁵-5-methylindenyl group, η⁵-6-methylindenyl group, η⁵-7-methylindenyl group, η⁵-2-tert-butylindenyl group, η⁵-3-tert-butylindenyl group, η⁵-4-tert-butylindenyl group, η⁵-5-tert-butylindenyl group, η⁵-6-tert-butylindenyl group, η⁵-7-tert-butylindenyl group, η⁵-2,3-dimethylindenyl group, η⁵-2,4,7-trimethylindenyl group, η⁵-2-methyl-4-isopropylindenyl group, η⁵-4,5-benzindenyl group, η⁵-4-phenylindenyl group, η⁵-2-methyl-5-phenylindenyl group, η⁵-2-methyl-4-phenylindenyl group, η⁵-2-methyl-4-naphthylindenyl group, η⁵-3-benzylindenyl group, and these groups which are substituted. In this specification, “η⁵” in the names of transition metal compounds is sometimes omitted.

The groups having a cyclopentadiene type anion skeleton are linked with each other through a crosslinking group containing one or two or more of carbon atoms, silicon atoms and germanium atoms. These crosslinking groups include, for example, alkylene groups such as ethylene group and propylene group; substituted alkylene groups such as dimethylmethylene group and diphenylmethylene group; substituted silylene groups such as silylene group, dimethylsilylene group, diphenylsilylene group and tetramethyldisilylene group; germylene groups such as dimethylgermylene group and diphenylgermylene group; and the like.

The meso-metallocene compound of the component (A) is preferably a transition metal compound having a meso-indene type anion skeleton and is represented by the following formula (2).

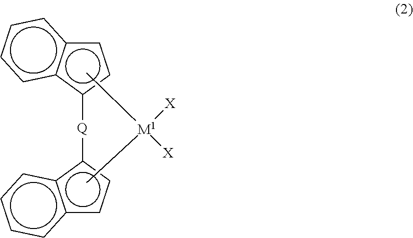

[in the formula, M¹ is a transition metal atom of Group 4 in the periodic table, X is a halogen atom, a hydrocarbon group (excluding group having cyclopentadiene type anion skeleton) or a hydrocarbonoxy group, and the indenyl skeletons are linked through a crosslinking group Q represented by the following formula (3) and are coordinated in meso form. A plurality of X may be the same or different.

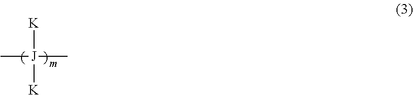

(in the formula, m is an integer of 1-5, J represents an atom of Group 14 in the periodic table, K is a hydrogen atom, a halogen atom, a hydrocarbon group (excluding group having cyclopentadiene type anion skeleton), a hydrocarbon group substituted with a substituted silyl group or a hydrocarbon group substituted with a substituted amino group, and a plurality of J may be the same or different. A plurality of K may be the same or different)].

In the formula (3), J is an atom of Group 14 in the periodic table (IUPAC 1989) and is carbon atom, silicon atom or germanium atom. J is more preferably carbon atom or silicon atom. A plurality of J may be the same or different.

X in the formula (1) and (2) is a halogen atom, a hydrocarbon group (excluding the group having cyclopentadiene type anion skeleton) or a hydrocarbonoxy group. Specific examples of the halogen atom are fluorine atom, chlorine atom, bromine atom and iodine atom. The hydrocarbon group here does not include the group having cyclopentadiene type anion skeleton. Examples of the hydrocarbon group are alkyl groups, aralkyl groups, aryl groups, alkenyl groups, etc. Examples of the hydrocarbonoxy group are alkoxy groups, aralkyloxy groups, aryloxy groups, etc. A plurality of X may be the same or different.

K in the formula (3) is a hydrogen atom, a halogen atom, a hydrocarbon group (excluding group having cyclopentadiene type anion skeleton), a hydrocarbonoxy group, a hydrocarbon group substituted with a substituted silyl group or a hydrocarbon group substituted with a substituted amino group. Examples of the halogen atom are fluorine atom, chlorine atom, bromine atom and iodine atom. The hydrocarbon group here does not include group having cyclopentadiene type anion skeleton. Examples of the hydrocarbon group here are alkyl groups, aralkyl groups, aryl groups, alkenyl groups, etc., and examples of the hydrocarbonoxy group are alkoxy groups, aralkyloxy groups, aryloxy groups, etc. A plurality of K may be the same or different.

The alkyl group in X and K includes, for example, methyl group, ethyl group, n-propyl group, isopropyl group, n-butyl group, sec-butyl group, tert-butyl group, isobutyl group, n-pentyl group, neopentyl group, amyl group, n-hexyl group, n-octyl group, n-decyl group, n-dodecyl group, n-pentadecyl group, n-eicosyl group, etc. These alkyl groups may be substituted with a halogen atom such as fluorine atom, chlorine atom, bromine atom, or iodine atom. Examples of the alkyl groups substituted with halogen atom are fluoromethyl group, trifluoromethyl group, chloromethyl group, trichloromethyl group, fluoroethyl group, pentafluoroethyl group, perfluoropropyl group, perfluorobutyl group, perfluorohexyl group, perfluorooctyl group, perchloropropyl group, perchiorobutyl group, perbromopropyl group, etc. Furthermore, these alkyl groups may be partially substituted with an alkoxy group such as methoxy group or ethoxy group; an aryloxy group such as phenoxy group; an aralkyloxy group such as benzyloxy group; or the like.

The aralky group in X and K includes, for example, benzyl group, (2-methylphenyl)methyl group, (3-methylphenyl)methyl group, (4-methylphenyl)methyl group, (2,3-dimethylphenyl)methyl group, (2,4-dimethylphenyl)methyl group, (2,5-dimethylphenyl)methyl group, (2,6-dimethylphenyl)methyl group, (3,4-dimethylphenyl)methyl group, (3,5-dimethylphenyl)methyl group, (2,3,4-trimethylphenyl)methyl group, (2,3,5-trimethylphenyl)methyl group, (2,3,6-trimethylphenyl)methyl group, (3,4,5-trimethylphenyl)methyl group, (2,4,6-trimethylphenyl)methyl group, (2,3,4,5-tetramethylphenyl)methyl group, (2,3,4,6-tetramethylphenyl)methyl group, (2,3,5,6-tetramethylphenyl)methyl group, (pentamethylphenyl)methyl group, (ethylphenyl)methyl group, (n-propylphenyl)methyl group, (isopropylphenyl)methyl group, (n-butylphenyl)methyl group, (sec-butylphenyl)methyl group, (tert-butylphenyl)methyl group, (n-pentylphenyl)methyl group, (neopentylphenyl)methyl group, (n-hexylphenyl)methyl group, (n-octylphenyl)methyl group, (n-decylphenyl)methyl group, (n-dodecylphenyl)methyl group, naphthylmethyl group, and anthracenylmethyl group, and these aralkyl groups may be partially substituted with a halogen atom such as fluorine atom, chlorine atom, bromine atom or iodine atom; an alkoxy group such as methoxy group or ethoxy group; an aryloxy group such as phenoxy group; an aralkyloxy group such as benzyloxy group; or the like.

The aryl group in X and K includes, for example, phenyl group, 2-tolyl group, 3-tolyl group, 4-tolyl group, 2,3-xylyl group, 2,4-xylyl group, 2,5-xylyl group, 2,6-xylyl group, 3,4-xylyl group, 3,5-xylyl group, 2,3,4-trimethylphenyl group, 2,3,5-trimethylphenyl group, 2,3,6-trimethylphenyl group, 2,4,6-trimethylphenyl group, 3,4,5-trimethylphenyl group, 2,3,4,5-tetramethylphenyl group, 2,3,4,6-tetramethylphenyl group, 2,3,5,6-tetramethylphenyl group, pentamethylphenyl group, ethylphenyl group, n-propylphenyl group, isopropylhenyl group, n-butylphenyl group, sec-butylphenyl group, tert-butylphenyl group, n-pentylphenyl group, neopentylphenyl group, n-hexylphenyl group, n-octylphenyl group, n-decylphenyl group, n-dodecylphenyl group, n-tetradecylphenyl group, naphthyl group, and anthracenyl group, and these aryl groups may be partially substituted with a halogen atom such as fluorine atom, chlorine atom, bromine atom or iodine atom; an alkoxy group such as methoxy group or ethoxy group; an aryloxy group such as phenoxy group; an aralkyloxy group such as benzyloxy group; or the like.

The alkenyl group in X and K includes, for example, allyl group, methallyl group, crotyl group and 1,3-diphenyl-2-propenyl group.

The alkoxy group in X and K includes, for example, methoxy group, ethoxy group, n-propoxy group, isopropoxy group, n-butoxy group, sec-butoxy group, tert-butoxy group, n-pentoxy group, neopentoxy group, n-hexoxy group, n-octoxy group, n-dodesoxy group, n-pentadesoxy group, and n-icosoxy group, and these alkoxy groups may be partially substituted with a halogen atom such as fluorine atom, chlorine atom, bromine atom or iodine atom; an alkoxy group such as methoxy group or ethoxy group; an aryloxy group such as phenoxy group; an aralkyloxy group such as benzyloxy group; or the like.

The aralkyloxy group in X and K includes, for example, benzyloxy group, (2-methylphenyl)methoxy group, (3-methylphenyl)methoxy group, (4-methylphenyl)methoxy group, (2,3-dimethylphenyl)methoxy group, (2,4-dimethylphenyl)methoxy group, (2,5-dimethylphenyl)methoxy group, (2,6-dimethylphenyl)methoxy group, (3,4-dimethylphenyl)methoxy group, (3,5-dimethylphenyl)methoxy group, (2,3,4-trimethylphenyl)methoxy group, (2,3,5-trimethylphenyl)methoxy group, (2,3,6-trimethylphenyl)methoxy group, (2,4,5-trimethylphenyl)methoxy group, (2,4,6-trimethylphenyl)methoxy group, (3,4,5-trimethylphenyl)methoxy group, (2,3,4,5-tetramethylphenyl)methoxy group, (2,3,4,6-tetramethylphenyl)methoxy group, (2,3,5,6-tetramethylphenyl)methoxy group, (pentamethylphenyl)methoxy group, (ethylphenyl)methoxy group, (n-propylphenyl)methoxy group, (isopropylhenyl)methoxy group, (n-butylphenyl)methoxy group, (sec-butylphenyl)methoxy group, (tert-butylphenyl)methoxy group, (n-hexylphenyl)methoxy group, (n-octylphenyl)methoxy group, (n-decylphenyl)methoxy group, naphthylmethoxy group, and anthracenylmethoxy group, and these aralkyloxy groups may be partially substituted with a halogen atom such as fluorine atom, chlorine atom, bromine atom or iodine atom; an alkoxy group such as methoxy group or ethoxy group; an aryloxy group such as phenoxy group; an aralkyloxy group such as benzyloxy group; or the like.

The aryloxy group in X and K includes, for example, phenoxy group, 2-methylphenoxy group, 3-methylphenoxy group, 4-methylphenoxy group, 2,3-dimethylphenoxy group, 2,4-dimethylphenoxy group, 2,5-dimethylphenoxy group, 2,6-dimethylphenoxy group, 3,4-dimethylphenoxy group, 3,5-dimethylphenoxy group, 2-tert-butyl-3-methylphenoxy group, 2-tert-butyl-4-methylphenoxy group, 2-tert-butyl-5-methylphenoxy group, 2-tert-butyl-6-methylphenoxy group, 2,3,4-trimethylphenoxy group, 2,3,5-trimethylphenoxy group, 2,3,6-trimethylphenoxy group, 2,4,5-trimethylphenoxy group, 2,4,6-trimethylphenoxy group, 2-tert-butyl-3,4-dimethylphenoxy group, 2-tert-butyl-3,5-dimethylphenoxy group, 2-tert-butyl-3,6-dimethylphenoxy group, 2,6-di-tert-butyl-3-methylphenoxy group, 2-tert-butyl-4,5-dimethylphenoxy group, 2,6-di-tert-butyl-4-methylphenoxy group, 3,4,5-trimethylphenoxy group, 2,3,4,5-tetramethylphenoxy group, 2-tert-butyl-3,4,5-trimethylphenoxy group, 2,3,4,6-tetramethylphenoxy group, 2-tert-butyl-3,4,6-trimethylphenoxy group, 2,6-di-tert-butyl-3,4-dimethylphenoxy group, 2,3,5,6-tetramethylphenoxy group, 2-tert-butyl-3,5,6-trimethylphenoxy group, 2,6-di-tert-butyl-3,5-dimethylphenoxy group, pentamethylphenoxy group, ethylphenoxy group, n-propylphenoxy group, isopropylphenoxy group, n-butylphenoxy group, sec-butylphenoxy group, tert-butylphenoxy group, n-hexylphenoxy group, n-octylphenoxy group, n-decylphenoxy group, n-tetradecylphenoxy group, naphthoxy group, and anthracenoxy group, and these aryloxy groups may be partially substituted with a halogen atom such as fluorine atom, chlorine atom, bromine atom or iodine atom; an alkoxy group such as methoxy group or ethoxy group; an aryloxy group such as phenoxy group; an aralkyloxy group such as benzyloxy group; or the like.

The hydrocarbon groups substituted with a substituted silyl group in K include, for example, trimethylsilylmethyl group, trimethylsilylethyl group, trimethylsilylpropyl group, trimethylsilylbutyl group, trimethylsilylphenyl group, bis(trimethylsilyl)methyl group, bis(trimethylsilyl)ethyl group, bis(trimethylsilyl)propyl group, bis(trimethylsilyl)butyl group, bis(trimethylsilyl)phenyl group, and triphenylsilylmethyl group.

The hydrocarbon groups substituted with a substituted amino group in K include, for example, dimethylaminomethyl group, dimethylaminoethyl group, dimethylaminopropyl group, dimethylaminobutyl group, dimethylaminophenyl group, bis(dimethylamino)methyl group, bis(dimethylamino)ethyl group, bis(dimethylamino)propyl group, bis(dimethylamino)butyl group, bis(dimethylamino)phenyl group, phenylaminomethyl group, diphenylaminomethyl group, and diphenylaminophenyl group.

Examples of the crosslinking group Q include, for example, alkylene groups such as ethylene group and propylene group; substituted alkylene groups such as dimethylmethylene group and diphenylmethylene group; substituted silylene groups such as silylene group, dimethylsilylene group, diphenylsilylene group and tetramethyldisilylene group; and germylene groups such as dimethylgermylene group and diphenylgermylene group.

As the specific examples of meso-metallocene compounds containing a group having a structure of two cyclopentadienyl type anion skeletons being bonded through a crosslinking group, mention may be made of titanium compounds such as meso-dimethylsilylenebis(indenyl)titanium dichloride, meso-dimethylsilylenebis(2-methylindenyl)titanium dichloride, meso-dimethylsilylenebis(2-tert-butylindenyl)titanium dichloride, meso-dimethylsilylenebis(2,3-dimethylindenyl)titanium dichloride, meso-dimethylsilylenebis(2,4,7-trimethylindenyl)titanium dichloride, meso-dimethylsilylenebis(2-methyl-4-isopropylindenyl)titanium dichloride, meso-dimethylsilylenebis(4,5-benzindenyl)titanium dichloride, meso-dimethylsilylenebis(2-phenylindenyl)titanium dichloride, meso-dimethylsilylenebis(4-phenylindenyl)titanium dichloride, meso-dimethylsilylenebis(2-methyl-4-phenylindenyl)titanium dichloride, meso-dimethylsilylenebis(2-methyl-5-phenylindenyl)titanium dichloride, meso-dimethylsilylenebis(2-methyl-4-naphthylindenyl)titanium dichloride, meso-dimethylsilylenebis(3-benzylindenyl)titanium dichloride, meso-dimethylsilylene(indenyl)(3-benzylindenyl)titanium dichloride, meso-dimethylsilylenebis(4,5,6,7-tetrahydroindenyl)titanium dichloride, etc; zirconium compounds such as meso-dimethylsilylenebis(indenyl)zirconium dichloride, meso-dimethylsilylenebis(2-methylindenyl)zirconium dichloride, meso-dimethylsilylenebis(2-tert-butylindenyl)zirconium dichloride, meso-dimethylsilylenebis(2,3-dimethylindenyl)zirconium dichloride, meso-dimethylsilylenebis(2,4,7-trimethylindenyl)zirconium dichloride, meso-dimethylsilylenebis(2-methyl-4-isopropylindenyl)zirconium dichloride, meso-dimethylsilylenebis(4,5-benzindenyl)zirconium dichloride, meso-dimethylsilylenebis(2-phenylindenyl)zirconium dichloride, meso-dimethylsilylenebis(4-phenylindenyl)zirconium dichloride, meso-dimethylsilylenebis(2-methyl-4-phenylindenyl)zirconium dichloride, meso-dimethylsilylenebis(2-methyl-5-phenylindenyl)zirconium dichloride, meso-dimethylsilylenebis(2-methyl-4-naphthylindenyl)zirconium dichloride, meso-dimethylsilylenebis(3-benzylindenyl)zirconium dichloride, meso-dimethylsilylene(indenyl)(3-benzylindenyl)zirconium dichloride, meso-dimethylsilylenebis(4,5,6,7-tetrahydroindenyl)zirconium dichloride, etc.; and hafnium compounds such as meso-dimethylsilylenebis(indenyl)hafnium dichloride, meso-dimethylsilylenebis(2-methylindenyl)hafnium dichloride, meso-dimethylsilylenebis(2-tert-butylindenyl)hafnium dichloride, meso-dimethylsilylenebis(2,3-dimethylindenyl)hafnium dichloride, meso-dimethylsilylenebis(2,4,7-trimethylindenyl)hafnium dichloride, meso-dimethylsilylenebis(2-methyl-4-isopropylindenyl)hafnium dichloride, meso-dimethylsilylenebis(4,5-benzindenyl)hafnium dichloride, meso-dimethylsilylenebis(2-phenylindenyl)hafnium dichloride, meso-dimethylsilylenebis(4-phenylindenyl)hafnium dichloride, meso-dimethylsilylenebis(2-methyl-4-phenylindenyl)hafnium dichloride, meso-dimethylsilylenebis(2-methyl-5-phenylindenyl)hafnium dichloride, meso-dimethylsilylenebis(2-methyl-4-naphthylindenyl)hafnium dichloride, meso-dimethylsilylenebis(3-benzylindenyl)hafnium dichloride, meso-dimethylsilylene(indenyl)(3-benzylindenyl)hafnium dichloride, meso-dimethylsilylenebis(4,5,6,7-tetrahydroindenyl)hafnium dichloride, etc. In the above compounds, dimethylsilylene may be changed to methylene, ethylene, dimethylmethylene(isopropylidene), diphenylmethylene, diethylsilylene, diphenylsilylene, dimethoxysilylene, dimethylgermylene or diphenylgermylene, and dichloride may be changed to difluoride, dibromide, diiodide, dimethyl, diethyl, diisopropyl, diphenyl, dibenzyl, dimethoxide, diethoxide, di(n-propoxide), di(isopropoxide), diphenoxide or di(pentafluorophenoxide).

The meso-metallocene compounds of the component (A) are preferably those which contain a group having a structure where two cyclopentadienyl type anion skeletons are bonded through a crosslinking group such as alkylene group or silylene group.

The cyclopentadienyl type anion skeletons are preferably indenyl group, methylindenyl group, and benzylindenyl group, and indenyl group is more preferred, and the crosslinking groups are preferably ethylene group, dimethylmethylene group, and dimethylsilylene group, and dimethylsilylene group is more preferred. More preferred meso-metallocene compounds are meso-ethylenebis(1-indenyl)zirconium dichloride and meso-dimethylsilylenebis(1-indenyl)zirconium dichloride, and as further preferred meso-metallocene compounds, mention may be made of meso-dimehylsilylenebis(1-indenyl)zirconium dichloride.

These transition metal compounds may be used each alone or in combination of two or more.

The component (B) is a solid promotor component comprising a compound which ionizes a metallocene compound to form an ionic complex and which is supported on a particulate carrier. As the compound which ionizes a metallocene compound to form an ionic complex, mention may be made of at lest one compound selected from compounds of metal atoms of Groups 1, 2, 12, 14 or 15 in the periodic table, organoaluminumoxy compounds and boron compounds.

The organoaluminum oxy compounds include cyclic aluminoxanes having a structure represented by the following formula (4), linear aluminoxanes having a structure represented by the following formula (5), modified aluminoxane compounds obtained by reacting the compound of the formula (4) and/or (5) with a compound having hydroxyl group, and the like. (In the formulas, R¹ and R² are hydrocarbon groups, and all R¹s and all R²s may be the same or different, a denotes an integer of 2 or more, and b denotes an integer of 1 or more.) The hydrocarbon groups of R¹ and R² are preferably hydrocarbon groups of 1-8 carbon atoms and more preferably alkyl groups.

[—Al(R¹)—O']ₐ (4)

R²[—Al(R²)—O—]_{b}AlR²₂ (5)

Specific examples of R¹ and R² in the cyclic aluminoxanes having a structure represented by the formula (4) and the linear aluminoxanes having a structure represented by the formula (5) are alkyl groups such as methyl group, ethyl group, n-propyl group, isopropyl group, n-butyl group, isobutyl group, n-pentyl group, and neopentyl group. The suffix a is an integer of 2 or more and suffix b is an integer of 1 or more. Preferably, R¹ and R² are methyl group or isobutyl group, and a is 2-40, and b is 1-40.

The above aluminoxane is produced by various processes. The processes are not particularly limited, and it is produced in accordance with known processes.

For example, it is produced by contacting with water a solution prepared by dissolving a trialkylaluminum (e.g., trimethylaluminum) in a suitable organic solvent (such as benzene or aliphatic hydrocarbon). Furthermore, there may be used a process of contacting a trialkylaluminum (e.g., trimethylaluminum) and a metal salt containing water of crystallization (e.g., copper sulfate hydrate). The aluminoxane obtained in this way or a commercially available aluminoxane is considered to be usually a mixture of aluminoxanes of the formulas (4) and (5).

It is also preferred to use a modified aluminoxane compound formed by reacting the above aluminoxanes (aluminoxanes of the formulas (4) and/or (5) with a compound having hydroxyl group. The compounds having hydroxyl group include alcohol, phenol or silanol.

Specific examples of the organoaluminumoxy compounds are methylaluminoxane, methylisobutylaluminoxane, etc.

The boron compounds include, for example, tris(pentafluorophenyl)borane, triphenylcarbeniumtetrakis(pentafluorophenyl)borate, tri(n-butyl)ammoniumtetrakis(pentafluorophenyl)borate, and N,N-dimethylaniliniumtetrakis(pentafluorophenyl)borate.

As the compounds of metal atoms of Group 1, 2, 12, 14 or 15 in the periodic table, mention may be made of solid catalyst components obtained by contacting the following components (b1), (b2) and (b3).
(b1): Compounds represented by the following formula (6)

M²L²_{c} (6)
(b2): Compounds represented by the following formula (7)

R³ₜ₋₁TH (7)
(b3): Compounds represented by the following formula (8)

R⁴ₜ₋₂TH₂ (8)

[In the above formulas, M² represents a metal atom of Group 1, 2, 12, 14 or 15 in the periodic table, and c represents a numeral corresponding to valence of M². L² represents hydrogen atom, a halogen atom or a hydrocarbyl group which may be substituted, and when a plurality of L²s are present, these may be the same or different. T represents independently of one another a nonmetal atom of Group 15 or 16 in the periodic table, and t represents a numeral corresponding to valence of T of the respective compounds. R³ represents a halogen atom, an electron attractive group, a halogenated group or a group having an electron attractive group, and when a plurality of R³ are present, these may be the same or different. R⁴ represents a hydrocarbyl group or halogenated hydrocarbyl group.]

M² in the formula (6) is a metal atom of Group 1, 2, 12, 14 or 15 in the periodic table. Examples of M² are lithium atom, sodium atom, potassium atom, rubidium atom, cesium atom, beryllium atom, magnesium atom, calcium atom, strontium atom, barium atom, zinc atom, germanium atom, tin atom, lead atom, antimony atom, bismuth atom, etc. Preferred are magnesium atom, calcium atom, strontium atom, barium atom, zinc atom, germanium atom, tin atom, and bismuth atom, and more preferred are magnesium atom, zinc atom, tin atom and bismuth atom, and further preferred is zinc atom.

c in the formula (6) represents a numeral corresponding to valence of M². For example, when M² is zinc atom, c is 2.

L² in the formula (6) represents a hydrogen atom, a halogen atom or a hydrocarbyl group which may be substituted, and when a plurality of L² are present, these may be the same or different.

Examples of the halogen atom of L² are fluorine atom, chlorine atom, bromine atom and iodine atom.

Examples of the hydrocarbyl group of L² which may be substituted are alkyl group, aralkyl group, aryl group, and halogenated alkyl group.

Examples of the alkyl group of L² are preferably alkyl groups of 1-20 carbon atoms, and examples thereof are methyl group, ethyl group, n-propyl group, isopropyl group, n-butyl group, sec-butyl group, tert-butyl group, n-pentyl group, neopentyl group, isopentyl group, n-hexyl group, n-heptyl group, n-octyl group, n-decyl group, n-nonyl group, n-dodecyl group, n-tridecyl group, n-tetradecyl group, n-pentadecyl group, n-hexadecyl group, n-heptadecyl group, n-octadecyl group, n-nonadecyl group, and n-eicosyl group. Preferred are methyl group, ethyl group, isopropyl group, tert-butyl group and isobutyl group.

Examples of the halogenated alkyl group of L² are preferably halogenated alkyl groups of 1-20 carbon atoms, and examples thereof are fluoromethyl group, difluoromethyl group, trifluoromethyl group, chloromethyl group, dichloromethyl group, trichloromethy group, bromomethyl group, dibromomethyl group, tribromomethyl group, iodomethyl group, diiodomethyl group, triiodomethyl group, fluoroethyl group, difluoroethyl group, trifluoroethyl group, tetrafluoroethyl group, pentafluoroethyl group, chloroethyl group, dichloroethyl group, trichloroethy group, tetrachloroethyl group, pentachloroethyl group, bromoethyl group, dibromoethyl group, tribromoethyl group, tetrabromoethyl group, pentabromoethyl group, perfluoropropyl group, perfluorobutyl group, perfluoropentyl group, perfluorohexyl group, perfluorooctyl group, perfluorododecyl group, perfluoropentadecyl group, perfluoroeicosyl group, perchloropropyl group, perchlorobutyl group, perchloropentyl group, perchlorohexyl group, perchlorooctyl group, perchlorododecyl group, perchloropentadecyl group, perchloroeicosyl group, perbromopropyl group, perbromobutyl group, perbromopentyl group, perbromohexyl group, perbromooctyl group, perbromododecyl group, perbromopentadecyl group, and perbromoeicosyl group.

The aralky groups of L² are preferably aralkyl groups of 7-20 carbon atoms, and examples thereof are benzyl group, (2-methylphenyl)methyl group, (3-methylphenyl)methyl group, (4-methylphenyl)methyl group, (2,3-dimethylphenyl)methyl group, (2,4-dimethylphenyl)methyl group, (2,5-dimethylphenyl)methyl group, (2,6-dimethylphenyl)methyl group, (3,4-dimethylphenyl)methyl group, (4,6-dimethylphenyl)methyl group, (2,3,4-trimethylphenyl)methyl group, (2,3,5-trimethylphenyl)methyl group, (2,3,6-trimethylphenyl)methyl group, (3,4,5-trimethylphenyl)methyl group, (2,4,6-trimethylphenyl)methyl group, (2,3,4,5-tetramethylphenyl)methyl group, (2,3,4,6-tetramethylphenyl)methyl group, (2,3,5,6-tetramethylphenyl)methyl group, (pentamethylphenyl)methyl group, (ethylphenyl)methyl group, (n-propylphenyl)methyl group, (isopropylphenyl)methyl group, (n-butylphenyl)methyl group, (sec-butylphenyl)methyl group, (tert-butylphenyl)methyl group, (n-pentylphenyl)methyl group, (neopentylphenyl)methyl group, (n-hexylphenyl)methyl group, (n-octylphenyl)methyl group, (n-decylphenyl)methyl group, (n-decylphenyl)methyl group, (n-tetradecylphenyl)methyl group, naphthylmethyl group, anthracenylmethyl group, phenylethyl group, phenylpropyl group, phenylbutyl group, diphenylmethyl group, diphenylethyl group, diphenylpropyl group, and diphenylbutyl group. Benzyl group is preferred. Furthermore, mention may be made of halogenated aralkyl groups of 7-20 carbon atoms substituted with a halogen atom such as fluorine atom, chlorine atom, bromine atom or iodine atom.

The aryl groups of L² are preferably aryl groups of 6-20 carbon atoms, and examples thereof are phenyl group, 2-tolyl group, 3-tolyl group, 4-tolyl group, 2,3-xylyl group, 2,4-xylyl group, 2,5-xylyl group, 2,6-xylyl group, 3,4-xylyl group, 3,5-xylyl group, 2,3,4-trimethylphenyl group, 2,3,5-trimethylphenyl group, 2,3,6-trimethylphenyl group, 2,4,6-trimethylphenyl group, 3,4,5-trimethylphenyl group, 2,3,4,5-tetramethylphenyl group, 2,3,4,6-tetramethylphenyl group, 2,3,5,6-tetramethylphenyl group, pentamethylphenyl group, ethylphenyl group, diethylphenyl group, triethylphenyl group, n-propylphenyl group, isopropylhenyl group, n-butylphenyl group, sec-butylphenyl group, tert-butylphenyl group, n-pentylphenyl group, neopentylphenyl group, n-hexylphenyl group, n-octylphenyl group, n-decylphenyl group, n-dodecylphenyl group, n-tetradecylphenyl group, naphthyl group, and anthracenyl group. Phenyl group is preferred. Furthermore, mention may be made of halogenated aryl groups of 6-20 carbon atoms substituted with a halogen atom such as fluorine atom, chlorine atom, bromine atom or iodine atom.

As L², preferred are hydrogen atom, alkyl groups or aryl groups, more preferred are hydrogen atom or alkyl groups, and further preferred are alkyl groups.

T in the formulas (7) and (8) represents a nonmetal atom of Group 15 or 16 in the periodic table, and Ts in the formulas (7) and (8) may be the same or different. Specific examples of the nonmetal atom of Group 15 are nitrogen atom and phosphorus atom, and specific examples of the nonmetal atom of Group 16 are oxygen atom and sulfur atom. T is preferably nitrogen atom or oxygen atom, and more preferably is oxygen atom.

The t in the formulas (7) and (8) represents a valence of T, and when T is a nonmetal atom of Group 15, t is 3, and when T is a nonmetal atom of Group 16, t is 2.

R³ in the formula (7) represents a halogen atom, an electron attractive group, a halogenated group or a group having an electron attractive group, and when a plurality of R³ are present, these may be the same or different. As indication for electron attraction, there is known substituent constant σ of Hammett's rule, and as the electron attractive group, mention may be made of a functional group having a positive substituent constant σ of Hammett's rule.

Examples of the halogen atom of R³ are fluorine atom, chlorine atom, bromine atom and iodine atom.

Examples of the electron attractive group of R³ are cyanogroup, nitro group, carbonyl group, hydrocarbyloxycarbonyl group, sulfone group and phenyl group.

Examples of the halogenated group of R³ are halogenated alkyl groups, halogenated aralkyl groups, halogenated aryl groups, and halogenated hydrocarbyl groups such as (halogenated alkyl) aryl groups; halogenated hydrocarbyloxy groups; and halogenated hydrocarbyloxycarbonyl groups. Examples of the group having an electron attractive group of R³ are cyanated hydrocarbyl groups such as cyanated aryl groups, and nitrated hydrocarbyl groups such as nitrated aryl groups.

Examples of the halogenated alkyl group of R³ are fluoromethyl group, chloromethyl group, bromomethyl group, iodomethyl group, difluoromethyl group, dichloromethyl group, dibromomethyl group, diiodomethyl group, trifluoromethyl group, trichloromethyl group, tribromomethyl group, triiodemethyl group, 2,2,2-trifluoroethyl group, 2,2,2-trichloroethyl group, 2,2,2-tribromoethyl group, 2,2,2-triiodoethyl group, 2,2,3,3,3-pentafluoropropyl group, 2,2,3,3,3-pentachloropropyl group, 2,2,3,3,3-pentabromopropyl group, 2,2,3,3,3-pentaiodopropyl group, 2,2,2-trifluoro-1-trifluoromethylethyl group, 2,2,2-trichloro-1-trichloromethylethyl group, 2,2,2-tribromo-1-tribromomethylethyl group, 2,2,2-triiodo-1-triiodomethylethyl group, 1,1-bis(trifluoromethyl)-2,2,2-trifluoroethyl group, 1,1-bis(trichloromethyl)-2,2,2-trichloroethyl group, 1,1-bis(tribromomethyl)-2,2,2-tribromoethyl group, and 1,1-bis(triiodomethyl)-2,2,2-triiodoethyl group.

Examples of the halogenated aryl group of R³ are 2-fluorophenyl group, 3-fluorophenyl group, 4-fluorophenyl group, 2,4-difluorophenyl group, 2,6-difluorophenyl group, 3,4-difluorophenyl group, 3,5-difluorophenyl group, 2,4,6-trifluorophenyl group, 3,4,5-trifluorophenyl group, 2,3,5,6-tetrafluorophenyl group, pentafluorophenyl group, 2,3,5,6-tetrafluoro-4-trifluoromethylphenyl group, 2,3,5,6-tetrafluoro-4-pentafluorophenylphenyl group, perfluoro-1-naphthyl group, perfluoro-2-naphthyl group, 2-chlorophenyl group, 3-chlorophenyl group, 4-chlorophenyl group, 2,4-dichlorophenyl group, 2,6-dichlorophenyl group, 3,4-dichlorophenyl group, 3,5-dichlorophenyl group, 2,4,6-trichlorophenyl group, 3,4,5-trichlorophenyl group, 2,3,5,6-tetrachlorophenyl group, pentachlorophenyl group, 2,3,5,6-tetrachloro-4-trichloromethylphenyl group, 2,3,5,6-tetrachloro-4-pentachlorophenylphenyl group, perchloro-1-naphthyl group, per-chloro-2-naphthyl group, 2-bromophenyl group, 3-bromophenyl group, 4-bromophenyl group, 2,4-dibromophenyl group, 2,6-dibromophenyl group, 3,4-dibromophenyl group, 3,5-dibromophenyl group, 2,4,6-tribromophenyl group, 3,4,5-tribromophenyl group, 2,3,5,6-tetrabromophenyl group, pentabromophenyl group, 2,3,5,6-tetrabromo-4-tribromomethylphenyl group, 2,3,5,6-tetrabromo-4-pentabromophenylphenyl group, perbromo-1-naphthyl group, perbromo-2-naphthyl group, 2-iodophenyl group, 3-iodophenyl group, 4-iodophenyl group, 2,4-diiodophenyl group, 2,6-diiodophenyl group, 3,4-diiodophenyl group, 3,5-diiodophenyl group, 2,4,6-triiodophenyl group, 3,4,5-triiodophenyl group, 2,3,5,6-tetraiodophenyl group, pentaiodophenyl group, 2,3,5,6-tetraiodo-4-triiodomethylphenyl group, 2,3,5,6-tetraiodo-4-pentaiodophenylphenyl group, periodo-1-naphthyl group, and periodo-2-naphthyl group.

Examples of the (halogenated alkyl)aryl group of R³ are 2-(trifluoromethyl)phenyl group, 3-(trifluoromethyl)phenyl group, 4-(trifluoromethyl)phenyl group, 2,6-bis(trifluoromethyl)phenyl group, 3,5-bis(trifluoromethyl)phenyl group, 2,4,6-tris(trifluoromethyl)phenyl group, and 3,4,5-tris(trifluoromethyl)phenyl group.

Examples of the cyanated aryl group of R³ are 2-cyanophenyl group, 3-cyanophenyl group and 4-cyanophenyl group.

Examples of the nitrated aryl group of R³ are 2-nitrophenyl group, 3-nitrophenyl group and 4-nitrophenyl group.

Examples of the hydrocarbyloxycarbonyl group of R³ are alkoxycarbonyl groups, aralkyloxycarbonyl groups, and aryloxycarbonyl groups, and more specifically methoxycarbonyl group, ethoxycarbonyl group, n-propoxycarbonyl group, isopropoxycarbonyl group, and phenoxycarbonyl group.

Examples of the halogenated hydrocarbyloxycarbonyl group of R³ are halogenated alkoxycarbonyl groups, halogenated aralkyloxycarbonyl groups, and halogenated aryloxycarbonyl groups, and more specific examples are trifluoromethoxycarbonyl group and pentafluorophenoxycarbonyl group.

R³ is preferably halogenated hydrocarbyl group, more preferably halogenated alkyl group or halogenated aryl group, further preferably fluorinated alkyl group, fluorinated aryl group, chlorinated alkyl group or chlorinated aryl group, especially preferably fluorinated alkyl group or fluorinated aryl group. The fluorinated alkyl groups are preferably fluoromethyl group, difluoromethyl group, trifluoromethyl group, 2,2,2-trifluoroethyl group, 2,2,3,3,3-pentafluoropropyl group, 2,2,2-trifluoro-1-trifluoromethylethyl group, and 1,1-bis(trifluoromethyl)-2,2,2-trifluoroethyl group, and more preferably trifluoromethyl group, 2,2,2-trifluoro-1-trifluoromethylethyl group, and 1,1-bis(trifluoromethyl)-2,2,2-trifluoroethyl group. The fluorinated aryl groups are preferably 2-fluorophenyl group, 3-fluorophenyl group, 4-fluorophenyl group, 2,4-difluorophenyl group, 2,6-difluorophenyl group, 3,4-difluorophenyl group, 3,5-difluorophenyl group, 2,4,6-trifluorophenyl group, 3,4,5-trifluorophenyl group, 2,3,5,6-tetrafluorophenyl group, pentafluorophenyl group, 2,3,5,6-tetrafluoro-4-trifluoromethylphenyl group, 2,3,5,6-tetrafluoro-4-pentafluorophenylphenyl group, perfluoro-1-naphthyl group and perfluoro-2-naphthyl group, and more preferably 3,5-difluorophenyl group, 3,4,5-trifluorophenyl group and pentafluorophenyl group. The chlorinated alkyl groups are preferably chloromethyl group, dichloromethyl group, trichloromethyl group, 2,2,2-trichloroethyl group, 2,2,3,3,3-pentachloropropyl group, 2,2,2-trichloro-1-trichloromethylethyl group and 1,1-bis(trichloromethyl)-2,2,2-trichloroethyl group. The chlorinated aryl groups are preferably 4-chlorophenyl group, 2,6-dichlorophenyl group, 3,5-dichlorophenyl group, 2,4,6-trichlorophenyl group, 3,4,5-trichlorophenyl group and pentachlorophenyl group.

R⁴ in the formula (8) represents a hydrocarbyl group or a halogenated hydrocarbyl group. The hydrocarbyl groups of R⁴ include alkyl groups, aralkyl groups and aryl groups, and as examples thereof, mention may be made of those which are exemplified as alkyl groups, aralkyl groups and aryl groups of L². The halogenated hydrocarbyl groups of R⁴ include halogenated alkyl groups, halogenated aralkyl groups, halogenated aryl groups and (halogenated alkyl)aryl groups, and as examples thereof, mention may be made of those which are exemplified as halogenated alkyl groups, halogenated aryl groups and (halogenated alkyl)aryl groups of R³.

R⁴ is preferably a halogenated hydrocarbyl group, and more preferably a fluorinated hydrocarbyl group.

As for the compounds represented by the formula (6) of the component (b1), examples of the compounds where M² is zinc are dialkylzinc such as dimethylzinc, diethylzinc, di-n-propylzinc, diisopropylzinc, di-n-butylzinc, diisobutylzinc or di-n-hexylzinc; diarylzinc such as diphenylzinc, dinaphthylzinc or bis(pentafluorophenyl)zinc; dialkenylzinc such as diallylzinc; bis(cyclopentadienyl)zinc; halogenated alkylzinc such as chlorinated methylzinc, chlorinated ethylzinc, chlorinated n-propylzinc, chlorinated isopropylzinc, chlorinated n-butylzinc, chlorinated isobutylzinc, chlorinated n-hexylzinc, brominated methylzinc, brominated ethylzinc, brominated n-propylzinc, brominated isopropylzinc, brominated n-butylzinc, brominated isobutylzinc, brominated n-hexylzinc, iodated methylzinc, iodated ethylzinc, iodated n-propylzinc, iodated isopropylzinc, iodated n-butylzinc, iodated isobutylzinc or iodated n-hexylzinc; halogenated zinc such as zinc fluoride, zinc chloride, zinc bromide or zinc iodide; or the like.

The compound represented by the formula (6) of the component (b1) is preferably dialkylzinc, more preferably dimethylzinc, diethylzinc, di-n-propylzinc, diisopropylzinc, di-n-butylzinc, diisobutylzinc or di-n-hexylzinc, and particularly preferably dimethylzinc or diethylzinc.

The compounds represented by the formula (7) of the component (b2) include, for example, amines, phosphies, alcohols, thiols, phenols, thiophenols, naphthols, naphthylthiols and carboxylic acid compounds.

Examples of the amines are di(fluoromethyl)amine, bis(difluoromethyl)amine, bis(trifluoromethyl)amine, bis(2,2,2-trifluoroethyl)amine, bis(2,2,3,3,3-pentafluoropropyl)amine, bis(2,2,2-trifluo-1-trifluoromethylethyl)amine, bis(1,1-bis(trifluoromethyl)-2,2,2-trifluoroethyl)amine, bis(2-fluorophenyl)amine, bis(3-fluorophenyl)amine, bis(4-fluorophenyl)amine, bis(2,6-difluorophenyl)amine, bis(3,5-difluorophenyl)amine, bis(2,4,6-trifluorophenyl)amine, bis(3,4,5-trifluorophenyl)amine, bis(pentafluorophenyl)amine, bis(2-(trifluoromethyl)phenyl)amine, bis(3-(trifluoromethyl)phenyl)amine, bis(4-(trifluoromethyl)phenyl)amine, bis(2,6-di(trifluoromethyl)phenyl)amine, bis(3,5-di(trifluoromethyl)phenyl)amine, bis(2,4,6-tri(trifluoromethyl)phenyl)amine, bis(2-cyanophenyl)amine, (3-cyanophenyl)amine, bis(4-cyanophenyl)amine, bis(2-nitrophenyl)amine, bis(3-nitrophenyl)amine, bis(4-nitrophenyl)amine, bis(1H,1H-perfluorobutyl)amine, bis(1H,1H-perfluoropentyl)amine, bis(1H,1H-perfluorohexyl)amine, bis(1H,1H-perfluorooctyl)amine, bis(1H,1H-perfluorododecyl)amine, bis(1H,1H-perfluoropentadecyl)amine, and bis(1H,1H-perfluoroeicosyl)amine. Further examples are the above amines where fluoro is changed to chloro, bromo or iodo.

As the phosphines, mention may be made of the above amines where the nitrogen atom is replaced with phosphorus atom. These phosphines are compounds shown by replacing “amine” in the above amines with “phosphine”.

Examples of the alcohols are fluoromethanol, difluoromethanol, trifluoromethanol, 2,2,2-trifluoroethanol, 2,2,3,3,3-pentafluoropropanol, 2,2,2-trifluo-1-trifluoromethylethanol, 1,1-bis(trifluoromethyl)-2,2,2-trifluoroethanol, 1H,1H-perfluorobutanol, 1H,1H-perfluoropentanol, 1H,1H-perfluorohexanol, 1H,1H-perfluorooctanol, 1H,1H-perfluorododecanol, 1H,1H-perfluoropentadecanol, and 1H,1H-perfluoroeicosanol. Further examples are the above alcohols where fluoro is changed to chloro, bromo or iodo.

The thiols include compounds which are the above alcohols where oxygen atom is changed to sulfur atom. These thiols are compounds shown by replacing “nol” in the above alcohols with “nthiol”.

Examples of the phenols are 2-fluorophenol, 3-fluorophenol, 4-fluorophenol, 2,4-difluorophenol, 2,6-difluorophenol, 3,4-difluorophenol, 3,5-difluorophenol, 2,4,6-trifluorophenol, 3,4,5-trifluorophenol, 2,3,5,6-tetrafluorophenol, pentafluorophenol, 2,3,5,6-tetrafluoro-4-trifluoromethylphenol, and 2,3,5,6-tetrafluoro-4-pentafluorophenylphenol. Further examples are the above phenols where fluoro is changed to chloro, bromo or iodo.

The thiophenols include compounds which are the above phenols where oxygen atom is changed to sulfur atom. These thiophenols are compounds shown by replacing “phenol” in the above phenols with “thiophenol”.

Examples of the naphthols are perfluoro-1-naphthol, perfluoro-2-naphthol, 4,5,6,7,8-pentafluoro-2-naphthol, 2-(trifluoromethyl)phenol, 3-(trifluoromethyl)phenol, 4-(trifluoromethyl)phenol, 2,6-bis(trifluoromethyl)phenol, 3,5-bis(trifluoromethyl)phenol, 2,4,6-tris(trifluoromethyl)phenol, 2-cycanophenol, 3-cyanophenol, 4-cyanophenol, 2-nitrophenol, 3-nitrophenol, and 4-nitrophenol. Further examples are the above naphthols where fluoro is changed to chloro, bromo or iodo.

The naphthylthiols include those compounds which are the above naphthols where oxygen atom is changed to sulfur atom. These naphthylthiols are compounds shown by replacing “naphthol” in the above naphthols with “naphthylthiol”.

The carboxylic acid compounds include, for example, pentafluorobenzoic acid, perfluoroethanoic acid, perfluoropropanoic acid, perfluorobutanoic acid, perfluoropentanoic acid, perfluorohexanoic acid, perfluoroheptanoic acid, perfluorooctanoic acid, perfluorononanoic acid, perfluorodecanoic acid, perfluoroundecanoic acid, and perfluorododecanoic acid.

The compounds represented by the formula (7) of the component (b2) are preferably amines, alcohols and phenol compounds. The amines are preferably bis(trifluoromethyl)amine, bis(2,2,2-trifluoroethyl)amine, bis(2,2,3,3,3-pentafluoropropyl)amine, bis(2,2,2-trifluo-1-trifluoromethylethyl)amine, bis(1,1-bis(trifluoromethyl)-2,2,2-trifluoroethyl)amine and bis(pentafluorophenyl)amine; the alcohols are preferably trifluoromethanol, 2,2,2-trifluoroethanol, 2,2,3,3,3-pentafluoropropanol, 2,2,2-trifluo-1-trifluoromethylethanol and 1,1-bis(trifluoromethyl)-2,2,2-trifluoroethanol; the phenold are preferably 2-fluorophenol, 3-fluorophenol, 4-fluorophenol, 2,6-difluorophenol, 3,5-difluorophenol, 2,4,6-trifluorophenol, 3,4,5-trifluorophenol, 2,3,5,6-tetrafluorophenol, pentafluorophenol, 2-(trifluoromethyl)phenol, 3-(trifluoromethyl)phenol, 4-(trifluoromethyl)phenol, 2,6-bis(trifluoromethyl)phenol, 3,5-bis(trifluoromethyl)phenol, 2,4,6-tris(trifluoromethyl)phenol and 3,4,5-tris(trifluoromethyl)phenol.

The compounds represented by the formula (7) of the component (b2) are more preferably bis(trifluoromethyl)amine, bis(pentafluorophenyl)amine, trifluoromethanol, 2,2,2-trifluo-1-trifluoromethylethanol, 1,1-bis(trifluoromethyl)-2,2,2-trifluoroethanol, 2-fluorophenol, 3-fluorophenol, 4-fluorophenol, 2,6-difluorophenol, 3,5-difluorophenol, 2,4,6-trifluorophenol, 3,4,5-trifluorophenol, pentafluorophenol, 4-(trifluoromethyl)phenol, 2,6-bis(trifluoromethyl)phenol and 2,4,6-tris(trifluoromethyl)phenol, and further preferably 3,5-difluorophenol, 3,4,5-trifluorophenol, pentafluorophenol and 1,1-bis(trifluoromethyl)-2,2,2-trifluoroethanol.

The compounds represented by the formula (8) of the component (b3) include, for example, water, hydrogen sulfide, amines and aniline compounds.

Examples of the amines are alkylamines such as methylamine, ethylamine, n-propylamine, isopropylamine, n-butylamine, sec-butylamine, tert-butylamine, isobutylamine, n-pentylamine, neopentylamine, isopentylamine, n-hexylamine, n-octylamine, n-decylamine, n-dodecylamine, n-pentadecylamine and n-eicosylamine; aralkylamines such as benzylamine, (2-methylphenyl)methylamine, (3-methylphenyl)methylamine, (4-methylphenyl)methylamine, (2,3-dimethylphenyl)methylamine, (2,4-dimethylphenyl)methylamine, (2,5-dimethylphenyl)methylamine, (2,6-dimethylphenyl)methylamine, (3,4-dimethylphenyl)methylamine, (3,5-dimethylphenyl)methylamine, (2,3,4-trimethylphenyl)methylamine, (2,3,5-trimethylphenyl)methylamine, (2,3,6-trimethylphenyl)methylamine, (3,4,5-trimethylphenyl)methylamine, (2,4,6-trimethylphenyl)methylamine, (2,3,4,5-tetramethylphenyl)methylamine, (2,3,4,6-tetramethylphenyl)methylamine, (2,3,5,6-tetramethylphenyl)methylamine, (pentamethylphenyl)methylamine, (ethylphenyl)methylamine, (n-propylphenyl)methylamine, (isopropylphenyl)methylamine, (n-butylphenyl)methylamine, (sec-butylphenyl)methylamine, (tert-butylphenyl)methylamine, (n-pentylphenyl)methylamine, (neopentylphenyl)methylamine, (n-hexylphenyl)methylamine, (n-octylphenyl)methylamine, (n-decylphenyl)methylamine, (n-tetradecylphenyl)methylamine, naphthylmethylamine and anthracenylmethylamine; allylamine; and allylamine cyclopentadienylamine.

Furthermore, the amines include halogenated alkylamines such as fluoromethylamine, difluoromethylamine, trifluoromethylamine, 2,2,2-trifluoroethylamine, 2,2,3,3,3-pentafluoropropylamine, 2,2,2-trifluo-1-trifluoromethylethylamine, 1,1-bis(trifluoromethyl)-2,2,2-trifluoroethylamine, perfluoropropylamine, perfluorobutylamine, perfluoropentylamine, perfluoropentylamine, perfluorohexylamine, perfluorooctylamine, perfluorododecylamine, perfluoropentadecylamine and perfluoroeicosylamine. Further examples are the above amines where fluoro is changed to chloro, bromo or iodo.

Examples of the aniline compounds are aniline, naphthylamine, anthracenylamine, 2-methylaniline, 3-methylaniline, 4-methylaniline, 2,3-dimethylaniline, 2,4-dimethylaniline, 2,5-dimethylaniline, 2,6-dimethylaniline, 3,4-dimethylaniline, 3,5-dimethylaniline, 2,3,4-trimethylaniline, 2,3,5-trimethylaniline, 2,3,6-trimethylaniline, 2,4,6-trimethylaniline, 3,4,5-trimethylaniline, 2,3,4,5-tetramethylaniline, 2,3,4,6-tetramethylaniline, 2,3,5,6-tetramethylaniline, pentamethylaniline, 2-ethylaniline, 3-ethylaniline, 4-ethylaniline, 2,3-diethylaniline, 2,4-diethylaniline, 2,5-diethylaniline, 2,6-diethylaniline, 3,4-diethylaniline, 3,5-diethylaniline, 2,3,4-triethylaniline, 2,3,5-triethylaniline, 2,3,6-triethylaniline, 2,4,6-triethylaniline, 3,4,5-triethylaniline, 2,3,4,5-tetraethylaniline, 2,3,4,6-tetraethylaniline, 2,3,5,6-tetraethylaniline, and pentaethylaniline. Further examples are the above aniline compounds where ethyl is changed to n-propyl, isopropyl, n-butyl, sec-butyl, tert-butyl, n-pentyl, neopentyl, n-hexyl, n-octyl, n-decyl, n-dodecyl, n-tetradecyl, or the like.

Furthermore, the aniline compounds include 2-fluoroaniline, 3-fluoroaniline, 4-fluoroaniline, 2,6-difluoroaniline, 3,5-difluoroaniline, 2,4,6-trifluoroaniline, 3,4,5-trifluoroaniline, pentafluoroaniline, 2-(trifluoromethyl)aniline, 3-(trifluoromethyl)aniline, 4-(trifluoromethyl)aniline, 2,6-di(trifluoromethyl)aniline, 3,5-di(trifluoromethyl)aniline, 2,4,6-tri(trifluoromethyl)aniline and 3,4,5-tri(trifluoromethyl)aniline. Further examples are the above aniline compounds where fluoro is changed to chloro, bromo or iodo.

The compounds represented by the formula (8) of the component (b3) are preferably water, hydrogen sulfide, methylamine, ethylamine, n-propylamine, isopropylamine, n-butylamine, sec-butylamine, tert-butylamine, isobutylamine, n-octylamine, aniline, 2,6-dimethylaniline, 2,4,6-trimethylaniline, naphthylamine, anthracenylamine, benzylamine, trifluoromethylamine, pentafluoroethylamine, perfluoropropylamine, perfluorobutylamine, perfluoropentylamine, perfluorohexylamine, perfluorooctylamine, perfluorododecylamine, perfluoropentadecylamine, perfluoroeicosylamine, 2-fluoroaniline, 3-fluoroaniline, 4-fluoroaniline, 2,6-difluoroaniline, 3,5-difluoroaniline, 2,4,6-trifluoroaniline, 3,4,5-trifluoroaniline, pentafluoroaniline, 2-(trifluoromethyl)aniline, 3-(trifluoromethyl)aniline, 4-(trifluoromethyl)aniline, 2,6-bis(trifluoromethyl)aniline, 3,5-bis(trifluoromethyl)aniline, 2,4,6-tris(trifluoromethyl)aniline and 3,4,5-tris(trifluoromethyl)aniline, and especially preferably water, trifluoromethylamine, perfluorobutylamine, perfluorooctylamine, perfluoropentadecylamine, 2-fluoroaniline, 3-fluoroaniline, 4-fluoroaniline, 2,6-difluoroaniline, 3,5-difluoroaniline, 2,4,6-trifluoroaniline, 3,4,5-trifluoroaniline, pentafluoroaniline, 2-(trifluoromethyl)aniline, 3-(trifluoromethyl)aniline, 4-(trifluoromethyl)aniline, 2,6-bis(trifluoromethyl)aniline, 3,5-bis(trifluoromethyl)aniline, 2,4,6-tris(trifluoromethyl)aniline and 3,4,5-tris(trifluoromethyl)aniline. Most preferred are water and pentafluoroaniline.

The compound which ionizes a metallocene compound to form an ionic complex is preferably an organoaluminumoxy or a zinc compound.

The particulate carrier used for component (B) is hereinafter referred to as (b4).

As the particulate carrier of the component (b4), there may be suitably used solid materials insoluble in solvents used for preparation of polymerization catalyst or polymerization solvents. Porous materials are more suitably used, inorganic materials or organic polymers are further suitably used, and inorganic materials are most suitable.

The particulate carrier of the component (b4) preferably has a uniform particle diameter, and geometrical standard deviation of particle diameter based on volume is preferably 2.5 or less, more preferably 2.0 or less, further preferably 1.7 or less.

The inorganic materials of particulate carrier of the component (b4) include, for example, inorganic oxides, clay and clay minerals. These may be used in admixture.

As the inorganic oxides, mention may be made of, for example, SiO₂, Al₂O₃, MgO, ZrO₂, TiO₂, B₂O₃, CaO, ZnO, BaO, ThO₂, SiO₂—MgO, SiO₂—Al₂O₃, SiO₂—TiO₂, SiO₂—V₂O₅, SiO₂—Cr₂O₃, SiO₂—TiO₂—MgO, and mixtures of two or more of them. Of these inorganic oxides, SiO₂ and/or Al₂O₃ are preferred, and SiO₂ (silica) is especially preferred. These inorganic oxides may contain a small amount of carbonate, sulfate, nitrate or oxide component such as Na₂CO₃, K₂CO₃, CaCO₃, MgCO₃, Na₂SO₄, Al₂(SO₄)₃, BaSO₄, KNO₃, Mg(NO₃)₂, Al(NO₃)₃, Na₂O, K₂O or Li₂O.

On the surface of inorganic oxides, usually, hydroxyl groups are formed and present, and as the inorganic oxides, there may be used modified inorganic oxides in which active hydrogen of the hydroxyl groups on the surface is substituted with various substituents. As the modified inorganic oxides, mention may be made of inorganic oxides which are allowed to contact with trialkylchlorosilanes such as trimethylchlorosilane and tert-butyldimethylchlorosilane; triarylchlorosilanes such as triphenylchlorosilane; dialkyldichlorosilanes such as dimethyldichlorosilane; diaryldichlrosilanes such as diphenyldichlorosilane; alkyltrichlorosilanes such as methyltrichlorosilane; aryltrichlorosilanes such as phenyltrichlorosilane; trialkylalkoxysilanes such as trimethylmethoxysilane; triarylalkoxysilanes such as triphenylmethoxysilane; dialkyldialkoxysilanes such as dimethyldimethoxysilane; diaryldialkoxysilanes such as diphenyldimethoxysilane; alkyltrialkoxysilanes such as methyltrimethoxysilane; aryltrialkoxysilanes such as phenyltrimethoxysilane; tetraalkoxysilanes such as tetramethoxysilane; alkyldisilazanes such as 1,1,1,3,3,3-hexamethyldisilazane; tetrachlrosilane; alcohols such as methanol and ethanol; phenol; dialkylmagnesium such as dibutylmagnesium, butylethylmagnesium and butyloctylmagnesium; and alkyllithium such as butyllithium.

Further examples are inorganic oxides allowed to contact with dialkylamines such as diethylamine and diphenylamine, alcohols such as methanol and ethanol, or phenol after contact with trialkylaluminum.

Strength of the inorganic oxides per se sometimes increases due to hydrogen bonding of hydroxyl groups per se. In this case, if all of active hydrogen of the surface hydroxyl groups is substituted with various substituents, there may be caused decrease in strength of the particles. Therefore, it is not necessary to substitute all of active hydrogen of hydroxyl groups on the surface of the inorganic oxides, and substitution degree of the hydroxyl groups on the surface can be optionally determined. The method for changing the substitution degree of the hydroxyl groups is not particularly limited. An example of the method is to change the amount of the compound used for the contacting.

Examples of clay or clay minerals are kaolin, bentonite, kibushi clay, gairome clay, allophone, hisingerite, pyrophyllite, talc, mica group, smectites, montmorillonite, hectorite, laponite, saponite, vermiculite, chlorite group, palygorskite, kaolinite, nacrite, dickite, and halloysite. Among them, preferred are smectites, montmorillonite, hectorite, laponite and saponite, and more preferred are montmorillonite and hectorite.

Inorganic oxides are suitable as the inorganic materials. The inorganic materials are preferably dried to substantially remove water, and dried preferably by heat treatment. With reference to the inorganic materials in which water cannot be recognized by visual observation, heat treatment is carried out at 100-1500° C., preferably 100-1000° C., more preferably 200-800° C. The heating time is preferably 10 minutes-50 hours, more preferably 1-30 hours. As the method for heating and drying, there may be used a method of drying by flowing dried inert gas (e.g., nitrogen or argon) at a specific flow rate during heating or a method of carrying out heating and drying under reduced pressure.

The average particle diameter of the inorganic materials is usually 1-5000 μm, preferably 5-1000 μm, more preferably 10-500 μm, further preferably 10-100 μm. The pore volume is preferably 0.1 ml/g or more, more preferably 0.3-10 ml/g. The specific surface area is preferably 10-1000 m²/g, and more preferably 100-500 m²/g.

The organic polymer of particulate carrier of the component (b4) is preferably a polymer having a functional group having active hydrogen or a polymer having a non-proton donating Lewis basic functional group.

As the functional group having active hydrogen, mention may be made of, for example, primary amino group, secondary amino group, imino group, amido group, hydrazido group, amidino group, hydroxy group, hydroperoxy group, carboxyl group, formyl group, carbamoyl group, sulfonic acid group, sulfinic acid group, sulfenic acid group, thiol group, thioformyl group, pyrrolyl group, imidazolyl group, piperidyl group, indazolyl group, and carbazolyl group. Preferred are primary amino group, secondary amino group, imino group, amido group, imido group, hydroxy group, formyl group, carboxyl group, sulfonic acid group and thiol group. Especially preferred are primary amino group, secondary amino group, amido group and hydroxy group. These groups may be substituted with a halogen atom or hydrocarbyl group of 1-20 carbon atoms.

The non-proton donating Lewis basic functional group is a functional group having Lewis base portion containing no active hydrogen atom, and mention may be made of, for example, pyridyl group, N-substituted imidazolyl group, N-substituted indazolyl group, nitrile group, azido group, N-substituted imino group, N,N-substituted amino group, N,N-substituted aminoxy group, N,N,N-substituted hydrazino group, nitroso group, nitro group, nitroxy group, furyl group, carbonyl group, thiocarbonyl group, alkoxy group, alkyloxycarbonyl group, N,N-substituted carbamoyl group, thioalkoxy group, substituted sulfinyl group, substituted sulfonyl group and substituted sulfonic acid group. Preferred are heterocyclic groups, and more preferred are aromatic heterocyclic groups having oxygen atom and/or nitrogen atom in the ring. Especially preferred are pyridyl group, N-substituted imidazolyl group and N-substituted indazolyl group, and most preferred is pyridyl group. These groups may be substituted with a halogen atom or a hydrocarbyl group of 1-20 carbon atoms.

In the organic polymer, the content of the functional group having active hydrogen or non-proton donating Lewis basic functional group is preferably 0.01-50 mmols/g and more preferably 0.1-20 mmols/g as a mol amount of the functional group per unit gram of polymer constituting the organic polymer.

As a method for producing the polymer which has the functional group having active hydrogen or non-proton donating Lewis basic functional group, for example, there is a method of homopolymerizing a monomer having a functional group having active hydrogen or non-proton donating Lewis basic functional group and one or more polymerizable unsaturated group or a method of copolymerizing the above monomer with other monomer having polymerizable unsaturated group. In this case, it is preferred to copolymerize together with additionally a crosslinking copolymerizable monomer having two or more polymerizable unsaturated groups.

Examples of the above polymerizable unsaturated group are alkenyl groups such as vinyl group and allyl group; and alkynyl groups such as ethyne.

The monomers having a functional group having active hydrogen and one or more polymerizable unsaturated group include vinyl group-containing primary amines, vinyl group-containing secondary amines, vinyl group-containing amide compounds, vinyl group-containing hydroxy compounds, etc. Examples of the monomers are N-(ethenyl)amine, N-(2-propenyl)amine, N-(1-ethenyl)-N-methylamine, N-(2-propenyl)-N-methylamine, 1-ethenylamide, 2-propenylamide, N-methyl-(1-ethenyl)amide, N-methyl-(2-propenyl)amide, vinyl alcohol, 2-propene-1-ol, and 3-butene-1-ol.

The monomers having functional group having Lewis base portion containing no active hydrogen atom and one or more polymerizable unsaturated group include, for example, vinylpyridine, vinyl(N-substituted)imidazole and vinyl(N-substituted)indazole.

As other monomers having polymerizable unsaturated group, mention may be made of, for example, ethylene, α-olefins, aromatic vinyl compounds and cyclic olefins. Examples of the monomers are ethylene, propylene, 1-butene, 1-hexene, 4-methyl-1-pentene, styrene, norbornene, and dicyclopentadiene. Two or more of these monomers may be used. Preferred are ethylene and styrene. Furthermore, the crosslinking polymerizable monomers having two or more polymerizable unsaturated groups include, for example, divinylbenzene.

The average particle diameter of the organic polymer is usually 1-5000 μm, preferably 5-1000 μm, more preferably 10-500 μm. The pore volume is preferably 0.1 ml/g or more, more preferably 0.3-10 ml/g. The specific surface area is preferably 10-1000 m²/g, and more preferably 50-500 m2/g.

The organic polymers are preferably dried to substantially remove water, and dried preferably by heat treatment. With reference to the organic polymers in which water cannot be recognized by visual observation, heat treating temperature is from 30 to 400° C., preferably from 50 to 200° C., more preferably from 70 to 150° C. The heating time is preferably 10 minutes-50 hours, more preferably 1-30 hours. As the method for heating and drying, there may be used a method of drying by flowing dried inert gas (e.g., nitrogen or argon) at a specific flow rate during heating or a method of carrying out heating and drying under reduced pressure.

The solid co-catalyst component of the component (B) comprises a compound which ionizes a metallocene compound to form an ionic complex and which is supported on a particulate carrier. The method of supporting may be any methods of contacting the compound which ionizes a metallocene compound to form an ionic complex with the particulate carrier, and an example of the methods is to contact them by mixing in a solvent. Further, there may be employed a method of preparing the compound which ionizes a metallocene compound to form an ionic complex in the presence of the particulate carrier.

The contacting treatment of the compound which ionizes a metallocene compound to form an ionic complex with the particulate carrier is carried out preferably in an inert gas atmosphere. The treating temperature is usually −100° C. to +300° C., preferably −80° C. to −200° C. The heating time is usually 1 minute to 200 hours, preferably 10 minutes to 100 hours. The contact treatment can be carried out using a solvent or can be directly carried out without using solvent.

As the solvent used for contact treatment, there may be used a solvent inert for the compound which ionizes a metallocene compound to form an ionic complex, and hydrocarbon solvents are usually used. Examples thereof are saturated hydrocarbon solvents such as butane, pentane, hexane, heptane, octane, 2,2,4-trimethylpentane and cyclohexane; and aromatic hydrocarbon solvents such as benzene, toluene and xylene.

When the compound which ionizes a metallocene compound to form an ionic complex in the solid co-catalyst component of component (B) is a compound of a metal atom of Group 1, 2, 12, 14 or 15 in the periodic table, the component (b1), component (b2) and component (b3) are contacted with the particulate carrier in the following order when the particulate carrier is referred to as (b4).

<1> Component (b1) and component (b2) are contacted, the resulting contact product is contacted with component (b3), and the resulting contact product is contacted with component (b4).

<2> Component (b1) and component (b2) are contacted, the resulting contact product is contacted with component (b4), and the resulting contact product is contacted with component (b3).

<3> Component (b1) and component (b3) are contacted, the resulting contact product is contacted with component (b2), and the resulting contact product is contacted with component (b4).

<4> Component (b1) and component (b3) are contacted, the resulting contact product is contacted with component (b4), and the resulting contact product is contacted with component (b2).

<5> Component (b1) and component (b4) are contacted, the resulting contact product is contacted with component (b2), and the resulting contact product is contacted with component (b3).

<6> Component (b1) and component (b4) are contacted, the resulting contact product is contacted with component (b3), and the resulting contact product is contacted with component (b2).

<7> Component (b2) and component (b3) are contacted, the resulting contact product is contacted with component (b1), and the resulting contact product is contacted with component (b4).

<8> Component (b2) and component (b3) are contacted, the resulting contact product is contacted with component (b4), and the resulting contact product is contacted with component (b1).

<9> Component (b2) and component (b4) are contacted, the resulting contact product is contacted with component (b1), and the resulting contact product is contacted with component (b3).

<10> Component (b2) and component (b4) are contacted, the resulting contact product is contacted with component (b3), and the resulting contact product is contacted with component (b1).

<11> Component (b3) and component (b4) are contacted, the resulting contact product is contacted with component (b1), and the resulting contact product is contacted with component (b2).

<12> Component (b3) and component (b4) are contacted, the resulting contact product is contacted with component (b2), and the resulting contact product is contacted with component (b1).

The contacting of component (b1), component (b2), component (b3) and component (b4) is preferably carried out in an inert gas atmosphere. The contacting temperature is usually −100° C. to +300° C., preferably −80° C. to +200° C. The contacting time is usually 1 minute to 200 hours, preferably 10 minutes to 100 hours. The contacting may be carried out using a solvent or may be directly carried out without using solvent.

In the case of using solvent, a solvent is used which does not react with component (b1), component (b2), component (b3) and component (b4), and the resulting contact product. However, when the components are contacted stepwise as aforementioned, even in the case of a solvent which reacts with a certain component at a certain step, if the solvent does not react with each component at other steps, this solvent can be used at the other steps. That is, the solvents at the respective steps are the same or different. As the solvents, there may be used, for example, non-polar solvents such as aliphatic hydrocarbon solvents and aromatic hydrocarbon solvents; and polar solvents such as halide solvents, ether solvents, alcohol solvents, phenol solvents, carbonyl solvents, phosphoric acid derivatives, nitrile solvents, nitro compounds, amine solvents and sulfur compounds. Specific examples are aliphatic hydrocarbon solvents such as butane, pentane, hexane, heptane, octane, 2,2,4-trimethylpentane and cyclohexane; aromatic hydrocarbon solvents such as benzene, toluene and xylene; halide solvents such as dichloromethane, difluoromethane, chloroform, 1,2-dichloroethane, 1,2-dibromoethane, 1,1,2-trichloro-1,2,2-trifluoroethane, tetrachloroethylene, chlorobenzene, bromobenzene and o-dichlorobenzene; ether solvents such as dimethyl ether, diethyl ether, diisopropyl ether, di-n-butyl ether, methyl-tert-butyl ether, anisole, 1,4-dioxane, 1,2-dimethoxyethane, bis(2-methoxyethyl)ether, tetrahydrofuran and tetrahydropyran; alcohol solvents such as methanol, ethanol, 1-propanol, 2-propanol, 1-butanol, 2-butanol, 2-methyl-1-propanol, 3-methyl-1-butanol, cyclohexanol, benzyl alcohol, ethylene glycol, propylene glycol, 2-methoxyethanol, 2-ethoxyethanol, diethylene glycol, triethylene glycol and glycerin; phenol solvents such as phenol and p-cresol; carbonyl solvents such as acetone, ethyl methyl ketone, cyclohexanone, acetic anhydride, ethyl acetate, butyl acetate, ethylene carbonate, propylene carbonate, N,N-dimethylformamide, N,N-dimethylacetamide and N-methyl-2-pyrrolidone; phosphoric acid derivatives such as hexamethylphosphoric acid triamide and triethyl phosphate; nitrile solvents such as acetonitrile, propionitrile, succinonitrile and benzonitrile; nitro compounds such as nitromethane and nitrobenzene; amine solvents such as pyridine, piperidine and morpholine; and sulfur compounds such as dimethyl sulfoxide and sulforan.

When the contact product (c) formed by contacting component (b1), component (b2) and component (b3) is contacted with component (b4), namely, in the above methods of <1>, <3> and <7>, solvent (s1) used in producing the contact product (c) is preferably the above-mentioned aliphatic hydrocarbon solvent, aromatic hydrocarbon solvent or ether solvent.

On the other hand, solvent (s2) in the case of contacting the contact product (c) and the component (b4) is preferably a polar solvent. As indication showing the polarity of the solvent, there is known E_{T}^{N} value (C. Reichardt, “Solvents and Solvents Effects in Organic Chemistry”, 2nd ed., VCH Verlag (1988)). A solvent satisfying 0.8≧E_{T}^{N}≧0.1 is particularly preferred.

Examples of such polar solvents are dichloromethane, dichlorodifluoromethane, chloroform, 1,2-dichloroethane, 1,2-dibromoethane, 1,1,2-trichloro-1,2,2-trifluoroethane, tetrachloroethylene, chlorobenzene, bromobenzene, o-dichlorobenzene, dimethyl ether, diethyl ether, diisopropyl ether, di-n-butyl ether, methyl-tert-butyl ether, anisole, 1,4-dioxane, 1,2-dimethoxyethane, bis(2-methoxyethyl)ether, tetrahydrofuran, tetrahydropyran, methanol, ethanol, 1-propanol, 2-propanol, 1-butanol, 2-butanol, 2-methyl-1-propanol, 3-methyl-1-butanol, cyclohexanol, benzyl alcohol, ethylene glycol, propylene glycol, 2-methoxyethanol, 2-ethoxyethanol, diethylene glycol, triethylene glycol, acetone, ethyl methyl ketone, cyclohexanone, acetic anhydride, ethyl acetate, butyl acetate, ethylene carbonate, propylene carbonate, N,N-dimethylformamide, N,N-dimethylacetamide, N-methyl-2-pyrrolidone, hexamethylphosphoric acid triamide, triethyl phosphate, acetonitrile, propionitrile, succinonitrile, benzonitrile, nitromethane, nitrobenzene, ethylenediamine, pyridine, piperidine, morpholine, dimethyl sulfoxide, and sulforan.

As solvents (s2), more preferred are dimethyl ether, diethyl ether, diisopropyl ether, di-n-butyl ether, methyl-tert-butyl ether, anisole, 1,4-dioxane, 1,2-dimethoxyethane, bis(2-methoxyethyl) ether, tetrahydrofuran, tetrahydropyran, methanol, ethanol, 1-propanol, 2-propanol, 1-butanol, 2-butanol, 2-methyl-1-propanol, 3-methyl-1-butanol, cyclohexanol, benzyl alcohol, ethylene glycol, propylene glycol, 2-methoxyethanol, 2-ethoxyethanol, diethylene glycol and triethylene glycol. Particularly preferred are di-n-butyl ether, methyl-tert-butyl ether, 1,4-dioxane, tetrahydrofuran, methanol, ethanol, 1-propanol, 2-propanol, 1-butanol, 2-butanol, 2-methyl-1-propanol, 3-methyl-1-butanol and cyclohexanol, and most preferred are tetrahydrofuran, methanol, ethanol, 1-propanol and 2-propanol.

As the solvents (s2), there may be used mixed solvents of the polar solvents and the hydrocarbon solvents. As the hydrocarbon solvents, there are used compounds exemplified above as the aliphatic hydrocarbon solvents and aromatic hydrocarbon solvents. Examples of the mixed solvents of the polar solvents and the hydrocarbon solvents are hexane/methanol mixed solvent, hexane/ethanol mixed solvent, hexane/1-propanol mixed solvent, hexane/2-propanol mixed solvent, heptane/methanol mixed solvent, heptane/ethanol mixed solvent, heptane/1-propanol mixed solvent, heptane/2-propanol mixed solvent, toluene/methanol mixed solvent, toluene/ethanol mixed solvent, toluene/1-propanol mixed solvent, toluene/2-propanol mixed solvent, xylene/methanol mixed solvent, xylene/ethanol mixed solvent, xylene/1-propanol mixed solvent, and xylene/2-propanol mixed solvent. Preferred are hexane/methanol mixed solvent, hexane/ethanol mixed solvent, heptane/methanol mixed solvent, heptane/ethanol mixed solvent, toluene/methanol mixed solvent, toluene/ethanol mixed solvent, xylene/methanol mixed solvent, and xylene/ethanol mixed solvent. More preferred are hexane/methanol mixed solvent, hexane/ethanol mixed solvent, toluene/methanol mixed solvent and toluene/ethanol mixed solvent. Toluene/ethanol mixed solvent is most preferred. The proportion of ethanol in the toluene/ethanol mixed solvent is preferably 10-50 vol %, more preferably 15-30 vol %.

When the contact product (c) formed by contacting component (b1), component (b2) and component (b3) is contacted with component (b4), namely, in the above methods of <1>, <3> and <7>, hydrocarbon solvents can be used as both the solvent (s1) and the solvent (s2). In this case, the time from contacting the component (b1), component (b2) and component (b3) until the resulting contact product (c) is contacted with component (b4) is preferably shorter. The time is preferably 0-5 hours, more preferably 0-3 hours and most preferably 0-1 hour. The temperature at which the contact product (c) is contacted with component (b4) is usually −100° C. to +40° C., preferably −20° C. to +20° C., most preferably −10° C. to +10° C.

In the above <2>, <5>, <6>, <8>, <9>, <10>, <11> and <12>, either of the above-mentioned non-polar solvents or polar solvents can be used. The non-polar solvents are preferred. It is considered that this is because the contact product of component (b1) and component (b3) or the contact product obtained by contacting the contact product of component (b1) and component (b2) with component (b3) is generally low in solubility in non-polar solvent, and hence, if the component (b4) is present in the reaction system when the contact product is produced, the contact product is precipitated on the surface of component (b4) and is more readily fixed.

Amounts of the component (b2) and (b3) used per 1 mol of the component (b1) used are preferably those which satisfy the following relationship (1).

[Valence of M²−mol of component (b2)−2×mol of component (b3)]≦1 (1)

Furthermore, the amount of the component (b2) used per 1 mol of the component (b1) used is preferably 0.01-1.99 mol, more preferably 0.1-1.8 mol, further preferably 0.2-1.5 mol, most preferably 0.3-1 mol. The preferred amount, more preferred amount, further preferred amount and most preferred amount of the component (b3) used per 1 mol of the component (b1) used is calculated from the valence of M³, the amount of the component (b2) used per 1 mol of the component (b1) used, and the above relationship (1).

The amounts of the components (b1) and (b2) used per 1 mol of the component (b1) used are such that the amount of the metal atom originating from the component (b1) contained in component (B) is preferably 0.1 mmol or more, more preferably 0.5-20 mols in terms of mol number of the metal atom contained in 1 g of the component (B).

In order to allow the reaction to proceed more rapidly, there may be added a step of heating at higher temperatures after contacting the components (b1), (b2), (b3) and (b4) as mentioned above. In the heating step, for attaining higher temperature, a solvent of high boiling point is preferably used, and in carrying out the heating step, the solvent used in contacting may be replaced with other solvent of higher boiling point.

As a result of the contacting, the components (b1), (b2), (b3) and (b4) which are starting materials may remain as unreacted materials in the component (B), but it is preferred to carry out previously a washing treatment to remove unreacted materials. The solvent in this case may be the same as or different from the solvent used in the contacting. The washing treatment is preferably carried out in an inert gas atmosphere. The contacting temperature is usually −100° C. to +300° C., preferably −80° C. to +200° C. The contacting time is usually 1 minute to 200 hours, preferably 10 minutes to 100 hours.

After the contact treatment and the washing treatment, it is preferred to distil off the solvent from the product and dry the product at a temperature of 0° C. or higher, for 1-24 hours under reduced pressure. The drying is carried out more preferably at from 0 to 200° C., for 1-24 hours, further preferably at from 10 to 200° C., for 1-24 hours, especially preferably at from 10 to 160° C., for 2-18 hours, and most preferably at 15-160° C., for 4-18 hours.

As the organoaluminum compound of component (C), known organoaluminum compound may be used. Preferred is an organoaluminum compound represented by the following formula (9).

R⁵_{d}AlY_{3-d} (9)

(in the formula, R represents a hydrocarbon group, and all R⁵s may be the same or different, Y represents hydrogen atom, a halogen atom, an alkoxy group, an aralkyloxy group or an aryloxy group, and all Ys may be the same or different, and d represents a numeral satisfying 0<d≦3).

In the formula (9) representing the organoaluminum compound, R⁵ is preferably a hydrocarbon group of 1-24 carbon atoms, and more preferably an alkyl group of 1-24 carbon atoms. Specific examples are methyl group, ethyl group, n-propyl group, n-butyl group, isobutyl group, n-hexyl group, 2-methylhexyl group, and n-octyl group, and preferred are ethyl group, n-butyl group, isobutyl group, n-hexyl group and n-octyl group.

Examples of halogen atom of Y are fluorine atom, chlorine atom, bromine atom, and iodine atom, and chlorine atom is preferred.

The alkoxy group in Y is preferably an alkoxy group of 1-24 carbon atoms. Specific examples are methoxy group, ethoxy group, n-propoxy group, isopropoxy group, n-butoxy group, sec-butoxy group, tert-butoxy group, n-pentoxy group, neopentoxy group, n-hexoxy group, n-octoxy group, n-dodesoxy group, n-pentadesoxy group, and n-icosoxy group, and methoxy group, ethoxy group and tert-butoxy group are preferred.

The aryloxy group in Y is preferably an aryloxy group of 6-24 carbon atoms. Specific examples thereof are phenoxy group, 2-methylphenoxy group, 3-methylphenoxy group, 4-methylphenoxy group, 2,3-dimethylphenoxy group, 2,4-dimethylphenoxy group, 2,5-dimethylphenoxy group, 2,6-dimethylphenoxy group, 3,4-dimethylphenoxy group, 3,5-dimethylphenoxy group, 2,3,4-trimethylphenoxy group, 2,3,5-trimethylphenoxy group, 2,3,6-trimethylphenoxy, 2,4,5-trimethylphenoxy group, 2,4,6-trimethylphenoxy group, 3,4,5-trimethylphenoxy group, 2,3,4,5-tetramethylphenoxy group, 2,3,4,6-tetramethylphenoxy group, 2,3,5,6-tetramethylphenoxy group, pentamethylphenoxy group, ethylphenoxy group, n-propylphenoxy group, isopropylphenoxy group, n-butylphenoxy group, sec-butylphenoxy group, tert-butylphenoxy group, n-hexylphenoxy group, n-octylphenoxy group, n-decylphenoxy group, n-tetradecylphenoxy group, naphthoxy group, and anthracenoxy group.

The aralkyloxy group in Y is preferably an aralkyloxy group of 7-24 carbon atoms. Specific examples thereof are benzyloxy group, (2-methylphenyl)methoxy group, (3-methylphenyl)methoxy group, (4-methylphenyl)methoxy group, (2,3-dimethylphenyl)methoxy group, (2,4-dimethylphenyl)methoxy group, (2,5-dimethylphenyl)methoxy group, (2,6-dimethylphenyl)methoxy group, (3,4-dimethylphenyl)methoxy group, (3,5-dimethylphenyl)methoxy group, (2,3,4-trimethylphenyl)methoxy group, (2,3,5-trimethylphenyl)methoxy group, (2,3,6-trimethylphenyl)methoxy group, (2,4,5-trimethylphenyl)methoxy group, (2,4,6-trimethylphenyl)methoxy group, (3,4,5-trimethylphenyl)methoxy group, (2,3,4,5-tetramethylphenyl)methoxy group, (2,3,5,6-tetramethylphenyl)methoxy group, (pentamethylphenyl)methoxy group, (ethylphenyl)methoxy group, (n-propylphenyl)methoxy group, (isopropylhenyl)methoxy group, (n-butylphenyl)methoxy group, (sec-butylphenyl)methoxy group, (tert-butylphenyl)methoxy group, (n-hexylphenyl)methoxy group, (n-octylphenyl)methoxy group, (n-decylphenyl)methoxy group, (n-tetradecylphenyl)methoxy group, naphthylmethoxy group, and anthracenylmethoxy group. Benzyloxy group is preferred.

Specific examples of the organoaluminum compounds represented by the formula (9) are trialkylaluminums such as trimethylaluminum, triethylaluminum, tri-n-propylaluminum, tri-n-butylaluminum, triisobutylaluminum, tri-n-hexylaluminum and tri-n-octylaluminum; dialkylaluminum chlorides such as dimethylaluminum chloride, diethylaluminum chloride, di-n-propylaluminum chloride, di-n-butylaluminum chloride, diisobutylaluminum chloride and di-n-hexylaluminum chloride; alkylaluminum dichlorides such as methylaluminum dichloride, ethylaluminum dichloride, n-propylaluminum dichloride, n-butylaluminum dichloride, isobutylaluminum dichloride and n-hexylaluminum dichloride; dialkylaluminum hydrides such as dimethylaluminum hydride, diethylaluminum hydride, di-n-propylaluminum hydride, di-n-butylaluminum hydride, diisobutylaluminum hydride and di-n-hexylaluminum hydride; alkyl(dialkoxy)aluminums such as methyl(dimethoxy)aluminum, methyl(diethoxy)aluminum and methyl(di-tert-butoxy)aluminum; dialkyl(alkoxy)aluminums such as dimethyl(methoxy)aluminum, dimethyl(ethoxy)aluminum and dimethyl(tert-butoxy)aluminum; alkyl(diaryloxy)aluminums such as methyl(diphenoxy)aluminum, methylbis(2,6-diisopropylphenoxy)aluminum and methylbis(2,6-diphenylphenoxy)aluminum; dialkyl(aryloxy)aluminums such as dimethyl(phenoxy)aluminum, dimethyl(2,6-diisopropylphenoxy)aluminum and dimethyl(2,6-diphenylphenoxy)aluminum.

Among them, preferred are trialkylaluminums, more preferred are trimethylaluminum, triethylaluminum, tri-n-butylaluminum, triisobutylaluminum, tri-n-hexylaluminum and tri-n-octylaluminum, and especially preferred are triisobutylaluminum, triethylaluminum and tri-n-octylaluminum.

These organoaluminum compounds may be used each alone or in combination of two or more.

The catalyst component for polymerization of ethylene of the present invention is obtained by contacting the above-mentioned component (A), component (B) and component (C). The amount of the component (A) used is usually 0.000001-0.001 mol, preferably 0.00001-0.001 mol for 1 g of the component (B). The amount of the component (C) used is usually 0.01-10000, preferably 0.1-10000 in molar ratio of component (C) to component (A) ((C)/(A)). In contacting the components (A), (B) and (C), two or more meso-metallocene compounds may be used as the component (A).

The proportion of the meso-metallocene compound in metallocene compounds is usually 95% by weight or more, preferably 97% by weight or more, more preferably 99% by weight or more.

The meso-metallocene compound can be obtained by the process such as recrystallization. Further, the proportion of the meso-metallocene compound in metallocene compounds can usually be obtained by an analytical method such as NMR.

For example, analysis value of ¹H-NMR of meso-dimethylsilylenebis(1-indenyl)zirconium dichloride which is one of meso-metallocene compounds is mentioned in Non-Patent Document 2.

In addition to ethylene, α-olefin can be copolymerized as far as the effect of the present invention is not damaged.

The α-olefins copolymerized with ethylene include, for example, olefins of from 3 to 20 carbon atoms such as propylene, 1-butene, 1-pentene, 1-hexene, 1-heptene, 1-octene, 1-nonene, 1-decene, 1-dodecene, 4-methyl-1-pentene and 4-methyl-1-hexene, or diolefins, cyclic olefins, alkenyl aromatic hydrocarbons, α,β-unsaturated carboxylic acids, etc. These may be used each alone or in combination of two or more.

The content of monomer units of α-olefins other than ethylene is usually 20% by weight or less, preferably 10% by weight or less, more preferably 5% by weight or less, further preferably 3% by weight or less based on total weight of polymer (100% by weight) from the viewpoint of reduction in production cost of polymer. Particularly, an ethylene homopolymer is preferred.

The method for feeding the catalyst components to a reactor for preparation of catalyst or a reactor for polymerization is also not particularly limited. There are, for example, a method of feeding each component in solid state, a method of feeding each component in the state of solution prepared by dissolving the component in a hydrocarbon solvent from which components deactivating the catalyst component such as water and oxygen are sufficiently removed, or in the state of suspension or slurry in the solvent. Examples of the solvent used in this case are aliphatic hydrocarbon solvents such as butane, pentane, hexane, heptane and octane, aromatic hydrocarbon solvents such as benzene and toluene, and halogenated hydrocarbons such as methylene chloride, and aliphatic hydrocarbon solvents and aromatic hydrocarbon solvents are preferred. There may be used two or more catalyst components for ethylene polymerization of the present invention.

The method for polymerization of ethylene using the catalyst components for ethylene polymerization of the present invention is also not particularly limited, and gas phase polymerization in gaseous monomer, slurry polymerization using a solvent, etc. can be employed. Ethylene per se can be used as a solvent (bulk polymerization). The polymerization method can be either batch-wise polymerization or continuous polymerization, and besides can be carried out in two or more stages differing in reaction condition. The polymerization time is generally optionally determined depending on the kind of desired olefin polymers and reactors, and usually a range of 1 minute to 20 hours can be employed. The catalyst component and monomer can be added to reactor by optional known methods and in optional order. For example, there may be employed a method of simultaneously adding each catalyst component and monomer, a method of consecutively adding them, etc. The catalyst components may be previously contacted in an inert atmosphere before they are contacted with monomer.

The slurry polymerization can be carried out in accordance with known slurry polymerization method and polymerization conditions. A preferred polymerization method in slurry method is to carry out the polymerization continuously using a continuous reactor to which monomer, diluent or the like is continuously added as required and from which a polymer product is continuously or at least periodically taken out. As the reactors, there may be used a loop reactor, an agitation reactor, etc. can be used. Moreover, there may be used a plurality of reactors differing in reaction conditions which are arranged in series and/or parallel.

The solvents used for slurry polymerization include, for example, saturated hydrocarbon solvents such as butane, pentane, hexane, heptane and octane, aromatic hydrocarbon solvents such as benzene and toluene, and halogenated hydrocarbon solvents such as methylene chloride.

As the diluents, there may be used, for example, inert diluents such as paraffin, cycloparaffin and aromatic hydrocarbons. The temperature of reaction zone of polymerization reactors is usually 0-150° C., preferably 30-100° C. The pressure can be changed to usually 0.1-10 MPa, and is preferably 0.5-5 MPa. Inert diluents, solvents, temperature and pressure can be selected so that the ethylene polymer can be produced as solid particles and recovered in that form.

As the conditions for slurry polymerization, the temperature is usually −30° C. to +150° C., preferably from 0 to 100° C., more preferably from 0 to 80° C. The polymerization activity can be enhanced by carrying out the polymerization at higher temperatures. Furthermore, the molecular weight of the resulting ethylene polymer can be increased by carrying out the polymerization at lower temperatures.

The gas phase polymerization can be carried out in accordance with known gas phase polymerization method and polymerization conditions. As the gas phase polymerization reactor, there is used a fluidized bed type reaction tank, preferably a fluidized bed type reaction tank having enlarged part. A reactor provided with an agitating element in the reaction tank may be used.

As the conditions for gas phase polymerization, the temperature is lower than the temperature at which the polymer is molten, preferably 0-150° C., particularly preferably 30-100° C. Inert gas may be allowed to coexist in the mixed gas in polymerization. The polymerization activity can be enhanced by carrying out the polymerization at higher temperatures. Furthermore, the molecular weight of the resulting ethylene polymer can be increased by carrying out the polymerization at lower temperatures.

The partial pressure of ethylene in polymerization is usually 0.01-10 MPa. For enhancing polymerization activity, the partial pressure is preferably 0.02 MPa or higher, more preferably 0.05 MPa or higher. For increasing the number of ethyl branches of the resulting ethylene polymer, it is preferably 5 MPa or lower, more preferably 2 MPa or lower, further preferably 1 MPa or lower.

In the present invention, a preliminary polymerization may be carried out before the above-mentioned polymerization (final polymerization).

An ethylene polymer of high molecular weight can be obtained by carrying out ethylene polymerization using the catalyst component for polymerization of ethylene which is obtained by contacting the components (A), (B) and (C) of the present invention, and furthermore, the molecular weight of the resulting ethylene polymer can be controlled by known means such as adjustment of temperature of reaction zone and introduction of hydrogen.

An ethylene homopolymer of high molecular weight having substantially only ethyl branch can be obtained by carrying out ethylene homopolymerization using the above catalyst component for polymerization of ethylene. Specifically, an ethylene homopolymer having 6 or more ethyl branches and 0.1 or less alkyl branches other than ethyl branch per 1000 carbon atoms and an intrinsic viscosity [η] of 0.7 or higher can be obtained. The ethylene homopolymer having 10 or more ethyl branches and 0.1 or less alkyl branch other than ethyl branch per 1000 carbon atoms means that when the ethylene homopolymer has methyl branch and butyl branch as alkyl branches other than ethyl branch, the number of the methyl branch is 0.1 or less, that of butyl branch is 0.1 or less, and that of ethyl branch is 10 or more per 1000 carbon atoms constituting the main chain of the ethylene homopolymer.

The number of ethyl branch is 6 or more per 1000 carbon atoms, and for increasing mechanical strength of the ethylene homopolymer, it is preferably 10 or more, more preferably 11 or more, further preferably 12 or more, and most preferably 13 or more.

The intrinsic viscosity [η] is 0.7 or higher, and for increasing mechanical strength of the ethylene polymer, it is preferably 0.8 or higher, more preferably 0.9 or higher.

The number of each alkyl branch per 1000 carbon atoms of the ethylene polymer can be obtained by measuring carbon nuclear magnetic resonance spectrum (¹³C-NMR) by carbon nuclear magnetic resonance method under the following conditions and carrying out calculation by the following calculation method.

<Measuring Conditions>

Apparatus: AVANCE 600 manufactured by Bruker Co., Ltd.

Measuring probe: 10 mm probe

Measuring solvent: Mixed solution of 1,2-dichlorobenzene/1,2-dichlorobenzene-d4=75/25 (volume ratio)

Measuring temperature: 130° C.

Measuring method: Proton decoupling method

Pulse width: 45°

Pulse repeating time: 4 seconds

Measuring standard: tetramethylsilane

Window function: Positive exponential function

The number of integration: Integration is conducted until SN ratio of peaks observed at 32.0-32.2 ppm reaches 100 or more. As for the standard of noise, the area. of 50-60 ppm is defined to be noise.

<Method for Calculation of the Number of Ethyl Branch>

When the sum total of integral values of all peaks observed at 5-50 ppm is assumed to be 1000, the sum of integral values of peaks observed at 39.5-40.0 ppm and integral values of peaks observed at 37.1-37.6 ppm is taken as the number of ethyl branch.

<Method for Calculation of the Number of Other Alkyl Branch>

When the sum total of integral values of all peaks observed at 5-50 ppm is assumed to be 1000, the integral value of peaks observed at 19-20 ppm is taken as the number of methyl branch, the integral value of peaks observed at 14.3-14.8 ppm is taken as the number of propyl branch, and the sum of integral values of peaks observed at 38.0-38.5 ppm is taken as the number of branch of 4 or more carbon atoms.

The intrinsic viscosity [η] of ethylene polymer can be obtained by the following method. A tetralin solution in which 2,6-di-t-butyl-p-cresol (BHT) is dissolved at a concentration of 0.5 g/L (hereinafter referred to as blank solution) and a solution prepared by dissolving ethylene polymer in the blank solution at a concentration of 1 mg/ml (hereinafter referred to as sample solution) are prepared. The falling time of the blank solution and the sample solution at 135° C. are measured by Ubbellohde viscometer, and relative viscosity [η rel] at 135° C. is obtained from the falling time. Then, the intrinsic viscosity [η] is calculated from the following formula.

[η]=23.3×log(ηrel)

It is considered that according to the present invention, an ethylene polymer having a high intrinsic viscosity [η] can be obtained by using as the component (B) a solid co-catalyst component comprising a particulate carrier and a compound which ionizes a metallocene compound to form an ionic complex and which is supported on the particulate carrier.

If necessary, the ethylene polymer obtained by the present invention may contain known additives such as, for example, foaming agent, foaming assistant, crosslinking agent, crosslinking assistant, antioxidant, weathering agent, lubricant, antiblocking agent, antistatic agent, anti-fogging agent, anti-dripping agent, pigment, and filler.

The ethylene polymer obtained by the present invention can be molded by known molding methods, for example, extrusion molding methods such as inflation film molding method and T-die film molding method, injection molding method, compression molding method, extrusion foaming method, atmospheric foaming method, and pressure foaming agent.

Moldings can be obtained using the ethylene polymer obtained by the process of the present invention. The moldings include, for example, pipes, tubes, containers, caps, films and sheets.

### EXAMPLES

The present invention will be explained using the following examples and comparative examples.

(1) Intrinsic Viscosity ([η], Unit: dl/g)

A tetralin solution in which 2,6-di-t-butyl-p-cresol (BHT) is dissolved at a concentration of 0.5 g/L (hereinafter referred to as blank solution) and a solution prepared by dissolving ethylene polymer in the blank solution at a concentration of 1 mg/ml (hereinafter referred to as sample solution) were prepared. The falling time of the blank solution and the sample solution at 135° C. were measured by Ubbellohde viscometer, and relative viscosity [ηrel] at 135° C. was obtained from the falling time. Then, the intrinsic viscosity [η] was calculated from the following formula.

[η]=23.3×log(ηrel)

(2) The Number of Ethyl Branch (Carbon Atom Number 2) (Unit: 1/1000C)

The number of ethyl branch was obtained by measuring carbon nuclear magnetic resonance spectrum (¹³C-NMR) by the carbon nuclear magnetic resonance method under the following conditions and carrying out calculation by the following calculation method.

<Measuring Conditions>

Apparatus: AVANCE 600 manufactured by Bruker Co., Ltd.

Measuring probe: 10 mm probe

Measuring solvent: Mixed solution of 1,2-dichlorobenzene/1,2-dichlorobenzene-d4=75/25 (volume ratio)

Measuring temperature: 130° C.

Measuring method: Proton decoupling method

Pulse width: 45°

Pulse repeating time: 4 seconds

Measuring standard: Tetramethylsilane

Window function: Positive exponential function

The number of integration: Integration was conducted until SN ratio of peaks observed at 32.0-32.2 ppm reached 100 or more. As for the standard of noise, the area of 50-60 ppm was defined to be noise.

<Method for Calculation of the Number of Ethyl Branches>

When the sum total of integral values of all peaks observed at 5-50 ppm was assumed to be 1000, the sum of integral values of peaks observed at 39.5-40.0 ppm and integral values of peaks observed at 37.1-37.6 ppm was taken as the number of ethyl branch.

<Method for Calculation of the Number of Other Alkyl Branches>

When the sum total of integral values of all peaks observed at 5-50 ppm was assumed to be 1000, the integral value of peaks observed at 19-20 ppm was taken as the number of methyl branches, the integral value of peaks observed at 14.3-14.8 ppm was taken as the number of propyl branches, and the sum total of integral values of peaks observed at 38.0-38.5 ppm was taken as the number of branches of 4 or more carbon atoms.

(3) Value of Terminal Vinylidene Group/Terminal Methyl Group

The value was obtained by measuring carbon nuclear magnetic resonance spectrum (¹³C-NMR) by carbon nuclear magnetic resonance method under the following conditions and carrying out calculation by the following calculation method.

<Measuring Conditions>

Apparatus: AVANCE 600 manufactured by Bruker Co., Ltd.

Measuring probe: 10 mm probe

Measuring solvent: A mixed solution of 1,2-dichlorobenzene/1,2-dichlorobenzene-d4=75/25 (volume ratio)

Measuring temperature: 130° C.

Measuring method: Proton decoupling method

Pulse width: 45°

Pulse repeating time: 4 seconds

Measuring standard: Tetramethylsilane

Window function: Positive exponential function

The number of integration: Integration was conducted until SN ratio of peaks observed at 32.0-32.2 ppm reached 100 or more. As for the standard of noise, the area of 50-60 ppm is defined to be noise.

<Method of Calculation>

The integral value of peaks observed at 36.4-36.6 ppm was taken as terminal vinylidene group, and the integral value of peaks observed at 32.0-32.2 ppm was taken as terminal methyl group, and the value of terminal vinylidene group/terminal methyl group was obtained.

(4) Value of Terminal Vinyl Group/Unsaturated Terminal Group, and Value of Terminal Vinylene Group/Unsaturated Terminal Group

The value was obtained by measuring proton nuclear magnetic resonance spectrum (¹H-NMR) by proton nuclear magnetic resonance method under the following conditions and carrying out calculation by the following calculation method.

<Measuring Conditions>

Apparatus: EX270 manufactured by Nippon Denshi Co., Ltd.

Measuring probe: 5 mm probe

Measuring solvent: 1,2-dichlorobenzene-d4

Concentration of measuring sample: 0.5 ml of measuring solvent based on 10 mg of polymer

Measuring temperature: 130° C.

Pulse width: 30°

Pulse repeating time: 7 seconds

Measuring standard: Tetramethylsilane

The number of integration: 64 times

<Method of Calculation>

The integral value of peaks observed at 4.86-5.02 ppm was taken as terminal vinyl group, and the sum of integral values of peaks observed at 4.64-4.80 ppm (vinylidene), 4.86-5.02 ppm (vinyl) and 5.30-5.53 ppm (trans-vinylene) was taken as terminal unsaturated group, and the value of terminal vinyl group/terminal unsaturated group was obtained.

Furthermore, the integral value of peaks observed at 5.30-5.53 ppm was taken as terminal vinylene group, and the sum of integral values of peaks observed at 4.64-4.80 ppm (vinylidene), 4.86-5.02 ppm (vinyl) and 5.30-5.53 ppm (trans-vinylene) was taken as terminal unsaturated group, and the value of terminal vinylene group/terminal unsaturated group was obtained.

(5) The Proportion of meso-dimethylsilylenebis(1-indenyl)zirconium dichloride in Metallocene Compounds

In the light of Non-Patent Document 2, the proportion was obtained by measuring proton nuclear magnetic resonance spectrum (¹H-NMR) by proton nuclear magnetic resonance method under the following conditions.

<Measuring Conditions>

Apparatus: EX270 manufactured by Nippon Denshi Co., Ltd.

Measuring probe: 5 mm probe

Measuring solvent: chloroform-d1

Concentration of measuring sample: 0.5 ml of measuring solvent based on 10 mg of sample

Measuring temperature: 25° C.

Pulse width: 30°

Pulse repeating time: 5 seconds

Measuring standard: As for the standard of chemical shift value, the peak of chloroform was assumed to be at 7.24 ppm.

The number of integration: 8 times

### Example 1

(1) Preparation of Solid Co-Catalyst Component

The inner space of an SUS-made reactor of 180 liters in internal volume having an agitator and a jacket was replaced with nitrogen, and then therein were introduced 9.7 kg of silica (Sylopol 948 manufactured by Devison Co., Ltd.; 50% volume average particle diameter=58 μm; pore volume=1.65 ml/g; specific surface area=298 m²/g) subjected to heat treatment at 300° C. under flowing of nitrogen and 100 liters of toluene. After cooling to 2° C., 23.3 kg (75.9 mols as Al atom) of a toluene solution of methylaluminoxane (PMAO-s manufactured by Tosoh Finechem Co., Ltd.) was dropped to the mixture over 62 minutes. After completion of dropping, agitation was carried out at 5° C. for 30 minutes, temperature was raised to 95° C. over 2 hours, and agitation was carried out at 95° C. for 4 hours. Thereafter, temperature was lowered to 40° C., and the content was transferred to an SUS-made reactor of 180 liters in internal volume having an agitator and a jacket which was subjected to nitrogen replacement. Component originating from silica was settled over 50 minutes, and liquid layer component was removed. Thereafter, 100 liters of toluene was added and agitation was carried out for 10 minutes as a washing operation, followed by settling the component originating from silica over about 45 minutes, and the upper layer component of the slurry was removed. The above washing operation was repeated thrice. Then, the slurry was transferred with 120 liters of toluene to an SUS-made filtering apparatus (having filter, agitator and jacket) of 430 liters in internal volume subjected to replacement with nitrogen. Filtration was carried out for 10 minutes, and agitation was again carried out for 10 minutes with addition of 100 liters of toluene, followed by filtration. Furthermore, as washing operation, 100 liters of hexane was added and agitation was carried out for 10 minutes, followed by filtration. This washing operation was repeated twice. The component originating from silica was transferred with 70 liters of hexane to an SUS-made dryer (having agitator and jacket) of 210 liters in internal volume subjected to replacement with nitrogen. Then, drying with flowing of nitrogen was conducted at a jacket temperature of 80° C. for 7.5 hours to obtain 12.6 kg of a solid component (hereinafter referred to as solid co-catalyst component (S1)).

(2) Polymerization

The inner space of an autoclave of 5 liters with an agitator subjected to replacement with argon after vacuum drying was made vacuous, and 1200 g of butane was charged therein, followed by raising the temperature in the system to 50° C. and then introducing ethylene at a partial pressure of 0.1 MPa to stabilize the system. Therein was introduced 1.5 mL of a hexane solution of triisobutylaluminum having a triisobutylaluminum concentration of 1 mmol/mL. Then, therein was introduced 3 mL of a toluene solution of meso-dimethylsilylenebis(1-indenyl)zirconium dichloride having a meso-dimethylsilylenebis(1-indenyl)zirconium dichloride concentration of 2 μmol/mL, followed by introducing 42.3 mg of the solid co-catalyst component (S1) obtained in Example 1(1). Polymerization was carried out at 50° C. for 240 minutes while continuously feeding ethylene gas so as to maintain the total pressure at constant during polymerization. Thereafter, butane and ethylene were purged to obtain 10.4 g of an ethylene homopolymer. The resulting ethylene homopolymer had a [η] of 0.93, contained only ethyl branch as alkyl branch, and had a number of ethyl branch of 13.2 (/1000C).

When ¹H-NMR was measured on meso-dimethylsilylenebis(1-indenyl)zirconium dichloride used for polymerization was measured, compounds other than meso-dimethylsilylenebis(1-indenyl)zirconium dichloride could not be confirmed.

### Example 2

(1) Preparation of Solid Co-Catalyst Component

In a reactor equipped with an agitator subjected to replacement with nitrogen were charged 2.8 kg of silica (Sylopol 948 manufactured by Devison Co., Ltd.; 50% volume average particle diameter=55 μm; pore volume=1.67 ml/g; specific surface area=325 m²/g) subjected to heat treatment at 300° C. with flowing of nitrogen and 24 kg of toluene. After cooling to 5° C., a mixed solution of 0.9 kg of 1,1,1,3,3,3-hexamethyldisilazane and 1.4 kg of toluene was dropped to the content of the reactor over 30 minutes while keeping the temperature of the reactor at 5° C. After completion of dropping, agitation was carried out at 5° C. for 1 hour, temperature was raised to 95° C., and agitation was carried out at 95° C. for 3 hours, followed by filtration. The resulting solid product was washed with 20.8 kg of toluene six times. Thereafter, 7.1 kg of toluene was added to prepare a slurry, which was left to stand overnight.

Into the slurry obtained above were introduced 1.73 kg of a hexane solution of diethylzinc (diethylzinc concentration: 50% by weight) and 1.02 kg of hexane, followed by agitation. Then, after cooling to 5° C., a mixed solution of 0.78 kg of 3,4,5-trifluorophenol and 1.44 kg of toluene was dropped over 60 minutes while keeping the temperature of the reactor at 5° C. After completion of dropping, agitation was carried out at 5° C. for 1 hour, and temperature was raised to 40° C., and agitation was carried out at 40° C. for 1 hour. Then, after cooling to 22° C., 0.11 kg of H₂O was dropped over 1.5 hour while keeping the temperature of the reactor at 22° C. After completion of dropping, agitation was carried out at 22° C. for 1.5 hour, temperature was raised to 40° C., and agitation was carried out at 40° C. for 2 hours. Furthermore, the temperature was raised to 80° C., and agitation was carried out at 80° C. for 2 hours. After the agitation, the supernatant liquid was drawn at room temperature until the amount of residue reached 16 L, and 11.6 kg of toluene was introduced, followed by raising the temperature to 95° C. and agitating for 4 hours. After the agitation, the supernatant liquid was drawn at room temperature to obtain a solid product. The resulting solid product was washed with 20.8 kg of toluene four times and with 24 liters of hexane thrice, followed by drying to obtain a solid component (hereinafter referred to as solid co-catalyst component (S2)).

(2) Polymerization

The inner space of an autoclave of 5 liters with an agitator subjected to replacement with argon after vacuum drying was made vacuous, and 0.002 MPa of hydrogen and 1200 g of butane were charged therein, followed by raising the temperature in the system to 50° C. and then introducing ethylene at a partial pressure of 0.1 MPa to stabilize the system. Therein was introduced 1.5 mL of a hexane solution of triisobutylaluminum having a triisobutylaluminum concentration of 1 mmol/mL. Then, therein was introduced 6 mL of a toluene solution of meso-dimethylsilylenebis(1-indenyl)zirconium dichloride having a meso-dimethylsilylenebis(1-indenyl)zirconium dichloride concentration of 1 μmol/mL, followed by introducing 36.4 mg of the solid co-catalyst component (S2) obtained in Example 2(1). Polymerization was carried out at 50° C. for 240 minutes while continuously feeding hydrogen ethylene mixed gas having a hydrogen concentration of 0.04% so as to maintain a constant total pressure during polymerization. Thereafter, butane and ethylene were purged to obtain 7.6 g of an ethylene homopolymer. The resulting ethylene homopolymer had a [η] of 1.2, contained only ethyl branch as alkyl branch, and had a number of ethyl branch of 6.7 (/1000C).

When ¹H-NMR was measured on meso-dimethylsilylenebis(1-indenyl)zirconium dichloride used for polymerization was measured, compounds other than meso-dimethylsilylenebis(1-indenyl)zirconium dichloride could not be confirmed.

### Comparative Example 1

(1) Polymerization

The inner space of an autoclave of 5 liters with an agitator subjected to replacement with argon after vacuum drying was made vacuous, and 1200 g of butane was charged therein, followed by raising the temperature in the system to 50° C. and then introducing ethylene at a partial pressure of 0.1 MPa to stabilize the system. Therein was introduced 11.0 mL of a hexane solution of methylaluminoxane (PMAO-s manufactured by Tosoh Finechem Co., Ltd.) having a methylaluminoxane concentration of 2.72 mmol/mL (concentration of methylaluminoxane based on the solvent was 30 mmol/mL). Then, therein was introduced 3 mL of a toluene solution of meso-dimethylsilylenebis(1-indenyl)zirconium dichloride having a meso-dimethylsilylenebis(1-indenyl)zirconium dichloride concentration of 2 μ mol/mL. Polymerization was carried out at 50° C. for 240 minutes while continuously feeding ethylene gas so as to maintain a constant total pressure during polymerization. Thereafter, butane and ethylene were purged to obtain 33.5 g of an ethylene polymer. The resulting ethylene homopolymer had a [η] of 0.66, contained only ethyl branch as alkyl branch observed in NMR measurement, and had a number of ethyl branch of 14.4 (/1000C). Furthermore, in NMR measurement, only ethylvinylidene structure was observed as an unsaturated terminal structure, and terminal vinyl group and terminal vinylene group were not observed, and the ratio of terminal vinylidene/terminal methyl was 0.87.

When ¹H-NMR was measured on meso-dimethylsilylenebis(1-indenyl)zirconium dichloride used for polymerization was measured, compounds other than meso-dimethylsilylenebis(1-indenyl)zirconium dichloride could not be confirmed.

1. A catalyst component for polymerization of ethylene which is obtained by contacting the following components (A), (B) and (C):
component (A): a meso-metallocene compound,
component (B): a solid co-catalyst component comprising a particulate carrier and a compound which ionizes a metallocene compound to form an ionic complex and which is supported on the particulate carrier, and
component (C): an organoaluminum compound.

2. A process for producing an ethylene polymer by polymerizing ethylene in the presence of the catalyst component for polymerization of ethylene according to claim 1.
